(19) United States
(12) Patent Application Publication
(10) Pub. No.: US 2026/0080905 A1
(43) Pub. Date: Mar. 19, 2026

(54) REMOTE COLLABORATIVE RECORDING SYSTEMS AND METHODS

(71) Applicant: DL360 Technology LLC, Kensington, MD (US)

(72) Inventors: Shawn Kyle Kingsberry, Kensington, MD (US); Kyle Anthony Kingsberry, Kensington, MD (US); Michael Andre Kingsberry, Charles Town, WV (US)

(73) Assignee: DL360 Technology LLC, Kensington, MD (US)

(21) Appl. No.: 19/331,157

(22) Filed: Sep. 17, 2025

Related U.S. Application Data
(60) Provisional application No. 63/695,536, filed on Sep. 17, 2024.

(51) Int. Cl. G11B 27/031; G06F 9/445; H04L 7/00

(52) U.S. Cl. CPC G11B 27/031; G06F 9/44526; H04L 7/0016

(57) ABSTRACT

Systems and methods for remote collaborative audio recording are disclosed. One aspect includes a studio computing system receiving a base track of a first audio recording. The studio computing system may transmit the base track over a computer network. A client computing system may receive the base track via the computer network, and record an audio track of a second audio recording. The audio track may be substantially time-synchronized with the base track. The client computing system may combine the audio track with the base track to generate a combined audio track, and transmit the combined audio track over the computer network. The studio computing system may receive the combined audio track via the computer network, and play the combined audio track without any network-induced time quantization error or time synchronization error between the base track and the audio track.

This application claims the priority benefit of provisional patent application No. 63/695,536 titled “Augmented Zero Latency (AZL) for Remote Professional Music Recording” filed on Sep. 17, 2024, the disclosure of which is incorporated by reference herein in its entirety.

### BACKGROUND

### Technical Field

The present disclosure relates to systems and methods that enable remote collaborative audio recording sessions.

### Background Art

The music recording industry has evolved significantly from its early days of recording in physical studios to today's digital age. In traditional recording studios, musicians, producers, and engineers worked together in the same space, allowing for real-time interaction, immediate feedback, and spontaneous creativity. This environment fostered a dynamic and cohesive creative process essential for producing high-quality music. However, as technology advanced, the industry began to explore digital recording solutions to enhance efficiency and accessibility.

The COVID-19 pandemic profoundly impacted the recording industry, highlighting the limitations of physical studios and accelerating the shift towards remote recording. Lockdowns and social distancing measures made it difficult, if not impossible, for artists and producers to gather in traditional studio settings. This disruption forced the industry to adapt, revealing the critical need for reliable remote recording solutions.

### SUMMARY

Aspects of the invention are directed to systems and methods for implementing remote audio recording sessions. One aspect includes a studio computing system receiving a base track of a first audio recording. The studio computing system may transmit the base track over a computer network. A client computing system may receive the base track via the computer network, and record an audio track of a second audio recording that is substantially time-synchronized with the base track.

In an aspect, the client computing system combines the audio track with the base track to generate a combined audio track, and transmits the combined audio track over the computer network. The studio computing system may receive the combined audio track via the computer network and play the combined audio track without any time quantization error or time synchronization error between the base track and the audio track.

In an aspect, the combining substantially eliminates any effects of a network delay that would otherwise result in a lack of synchronization between the base track and the audio track. The network delay may be associated with the computer network.

At least one operation of the studio computing system may be performed by a plugin instantiated on a digital audio workstation (DAW) installed on the studio computing system. In an aspect, this DAW includes a Tracktion engine.

In an aspect, at least one operation of the client computing system is performed by a plugin instantiated on a digital audio workstation (DAW) installed on the client computing system. This DAW may include a Tracktion engine.

One aspect may include initiating and conducting a video call between the studio computing system and the client computing system.

An aspect may include independently and separately authenticating a studio user and a client user on the studio computing system and the client computing system, respectively.

In an aspect, a keep or retake option for the audio track is provided on the client computing system.

If the retake option is selected, the audio track may be deleted and re-recorded to generate a re-recorded audio track.

In an aspect, the studio computing system transmitting the base track over the computer network comprises the studio computing system uploading the base track to a server via the computer network.

In an aspect, the client computing system receiving the base track via the computer network comprises the client computing system downloading the base track from the server via the computer network.

In an aspect, the client computing system transmitting the combined audio track over the computer network comprises the client computing system uploading the combined audio track to the server via the computer network.

In an aspect, the studio computing system receiving the combined audio track via the computer network comprises the studio computing system downloading the combined audio track from the server via the computer network.

The server may be an Amazon Web Services (AWS) server.

Aspects of the invention include apparatuses and/or systems that implement the above methods.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A is a block diagram depicting an embodiment of a system to perform remote audio recording as implemented in the prior art.

FIG. 1B is a timing diagram showing effects of network delay on a remote audio recording implemented using the prior art.

FIG. 2 is a block diagram depicting a remote audio recording system.

FIG. 3 is a block diagram depicting a workflow associated with a remote audio recording session.

FIG. 4 is a timing diagram showing a mitigation of the effects of network delay.

FIGS. 5A-5F are block diagrams depicting different components of a computing system.

FIGS. 6A-6B are flow diagrams depicting an interconnectivity between different components associated with a remote audio recording system.

FIGS. 7A-7F are process flow diagrams depicting a remote audio recording session.

FIGS. 8A-8B are flow diagrams depicting a method to implement a remote audio recording session.

FIGS. 9A-9C are data structure diagrams depicting different data structures and algorithmic functions associated with an implementation of a remote audio recording session.

FIG. 10 is a block diagram depicting an embodiment of a computing system.

FIG. 11 is a flow diagram depicting a method to implement a remote audio recording session.

FIGS. 12-18 are screenshots of different graphical user interfaces associated with a remote audio recording system.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the invention described herein address the shortcomings associated with contemporary collaborative remote recording systems. The music recording industry has evolved significantly from its early days of recording in physical studios to today's digital age. In traditional recording studios, musicians, producers, and engineers worked together in the same space, allowing for real-time interaction, immediate feedback, and spontaneous creativity. This environment fostered a dynamic and cohesive creative process essential for producing high-quality music. However, as technology advanced, the industry began to explore digital recording solutions to enhance efficiency and accessibility.

The COVID-19 pandemic profoundly impacted the recording industry, highlighting the limitations of physical studios and accelerating the shift towards remote recording. Lockdowns and social distancing measures made it difficult, if possible, for artists and producers to gather in traditional studio settings. This disruption forced the industry to adapt quickly, revealing the critical need for reliable remote recording solutions. It was learned that music recording is inherently a team sport requiring seamless collaboration tools to unite people, regardless of geographic location. This realization led to the creation of the remote audio recording systems and methods described herein, designed to address the challenges of professionally recording across distances and modernizing digital recording processes for today's musicians.

One aspect of the remote audio recording system bridges the gap between remote collaborators, ensuring that the creative process remains fluid and uncompromised. By integrating advanced cloud architecture, asynchronous coding, real-time audio and video communication, and robust security measures, this remote audio recording system offers a solution that replicates the in-studio experience virtually. This platform eliminates the traditional barriers of remote recording, such as latency, synchronization issues, and security concerns, allowing artists to collaborate in real-time with high-quality audio fidelity. The remote audio recording system not only modernizes digital recording but also democratizes access to professional-grade recording capabilities, enabling musicians worldwide to create and produce music without the constraints of physical location.

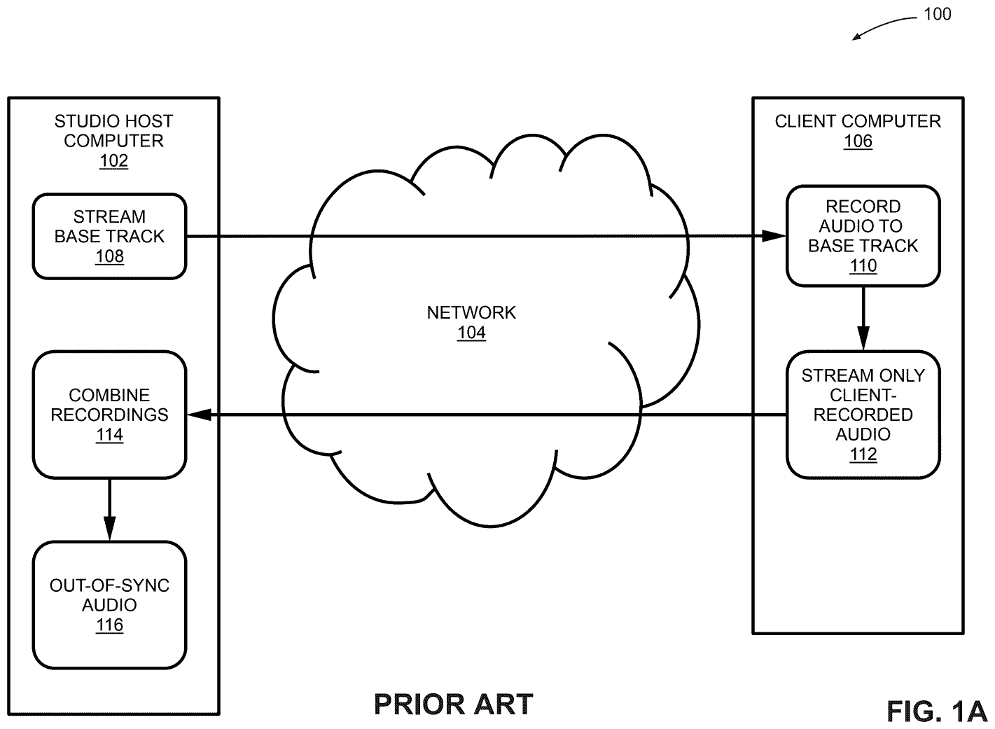

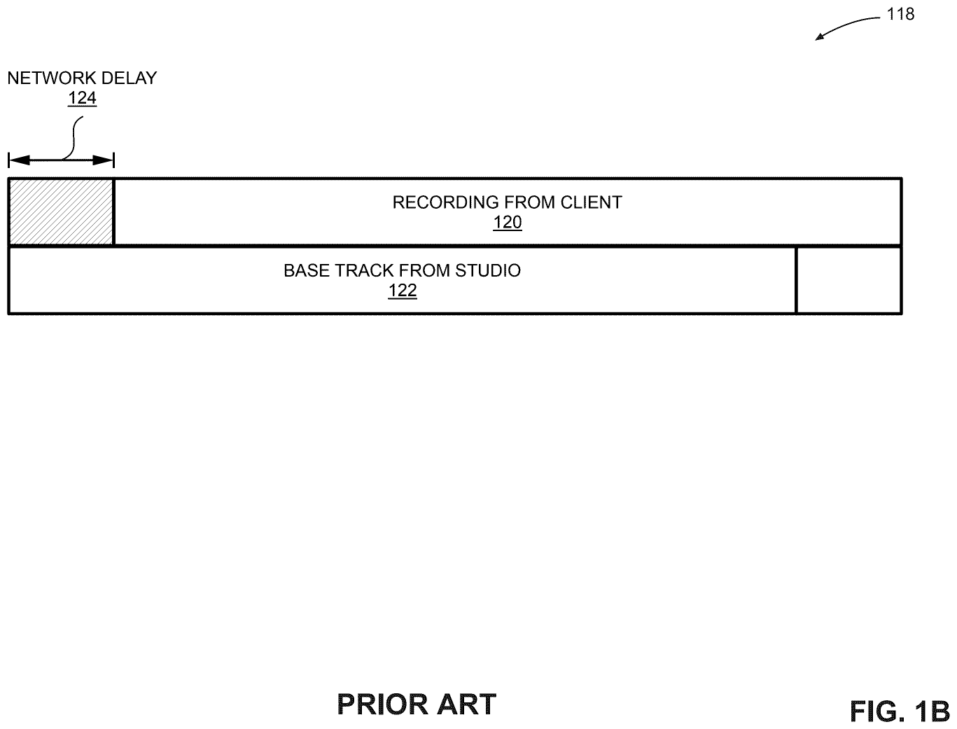

FIG. 1A is a block diagram depicting an embodiment of a system 100 to perform remote audio recording as implemented in the prior art. As depicted, system 100 includes studio host computer 102 connected to client computer 106 via network 104. Each of studio host computer 102 and client computer 106 may be a computing system such as a desktop computer, a laptop computer, a tablet, a mobile device, etc. As presented herein, the term “computing system” or “computing device” is generally used to describe a device with at least one processor, a memory and a network connection. Network 104 may be any type of computer network that communicatively couples studio host computer 102 and client computer 106. Examples of network 104 include the Internet, an intranet, a local area network (LAN), a virtual private network (VPN), a wide area network (WAN), a Bluetooth connection, etc.

Studio host computer 102 may be a computing system at an audio recording studio. Client computer 106 may be a computing system at client location that is remote from the audio recording studio. For example, a music artist using client computer 106 may wish to remotely collaborate with a musician or studio personnel at the audio recording studio. In general, as a part of a collaboration process, an (incomplete) audio recording may be transmitted or shared between several contributors. Each contributor may add additional parts or portions to the audio recording. When all portions from all contributors have been included in the audio recording, the audio recording may be considered complete or finished.

Studio host computer 102 may stream 108 a base track over network 104 to client computer 106. The base track may be a music track that contains an audio music recording of a portion of a completed musical piece. In other words, the base track may represent an incomplete musical audio track (or some other type of partially-complete audio recording associated with a collaborative recording process).

In an aspect, client computer 106 receives the base track via network 104. A client (e.g., an artist) associated with client computer 106 may record audio 110 to the base track. The recorded audio (audio recording) may include the client's contribution to the complete audio recording. The client computer 106 may stream 112 only the recorded audio over network 104.

At 114, the studio host computer 102 may receive the recorded audio and combine the recorded audio (audio recording) with the base track. However, due to inconsistent network delays associated with network 104, the base track and the recorded audio (audio recording) may be out of sync (i.e., not be synchronized) during playback 116.

A general process flow associated with system 100 is:
1. Studio host computer 102 streams base track to client (108)
2. Network lag between the current position in the song differs by a few milliseconds between the studio and the client, due to variable network delay/latency associated with network 104.
3. The client computer 106 then records to a track that is not atomically reproducible (110). In other words, the network latency will change over time, causing the base track that the client hears to have a varying delay relative to the track on the studio side.
4. The client computer 106 then streams their live recording in real-time back to the studio host computer 102 (112), and the stream experiences the same network latency effects for a second time.
5. The studio host computer 102 now receives the live recording from the client, which was recorded to a track with latency before having additional latency added when it was streamed back to the studio. Because the latency can vary over time, it cannot just be shifted by a deterministic amount, but must be quantized. This cannot happen in real-time, so playback of the combined audio can start only after the client finishes recording.

As depicted in FIG. 1A, the prior art solutions only combine the incoming base track with the client recording once the recording has been streamed back to the studio (i.e. to studio host computer 102). This causes the network latency to affect the clients' recording more than the base track and thus will require quantization before the combined audio can be played. Due to this, it is not feasible to stream the combined audio in real time.

FIG. 1B is a timing diagram 118 showing effects of network delay on a remote audio recording implemented using the prior art (e.g., by system 100). Timing diagram 118 shows a lack of synchronization between the base track 122 from studio host computer 102 and the recorded audio track 120 from the client (client computer 106). This lack of synchronization is due to the network delay 124, caused due to network delays associated with network 104.

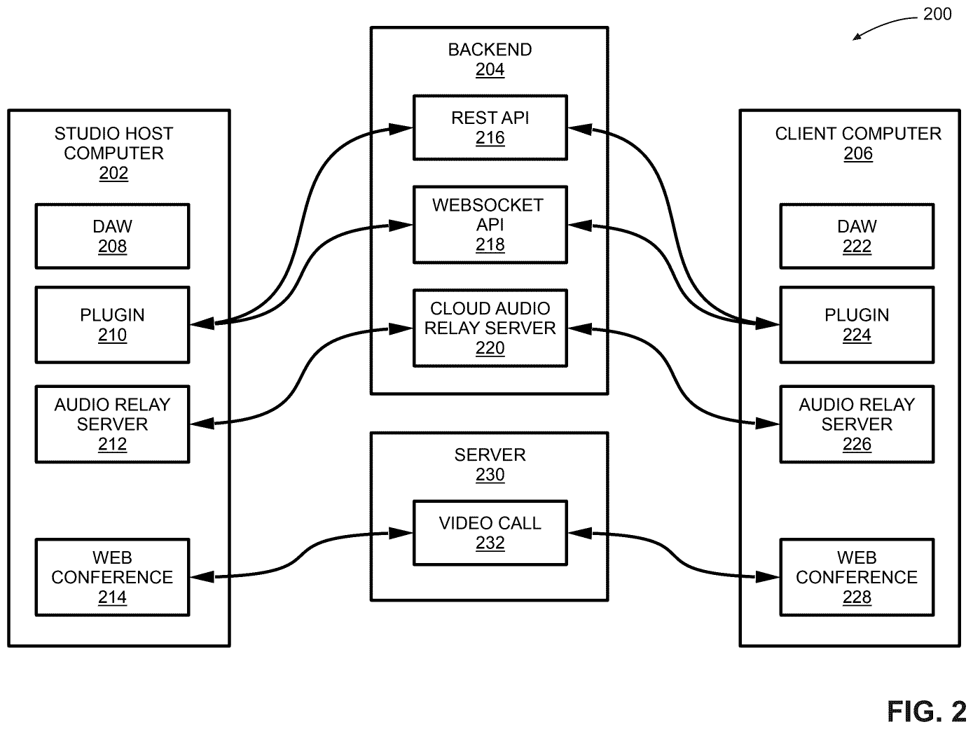

FIG. 2 is a block diagram depicting a remote audio recording system 200. In an aspect, remote audio recording system 200 functions as a collaborative remote audio recording system. As depicted, remote audio recording system 200 includes studio host computer 202, backend 204, client computer 206, and server 230. Studio host computer 202 further includes digital audio workstation (DAW) 208, plugin 210, audio relay server 212, and web conference 214. Client computer 206 further includes digital audio workstation (DAW) 222, plugin 224, audio relay server 226, and web conference 228. Backend 204 further includes REST API 216, WebSocket API 218, and cloud audio relay server 220. Server 230 further includes video call 232.

Each of DAW 208 and 222 may be a digital audio workstation that enables a user to perform different operations associated with audio recording processes. Examples of such operations include recording audio, editing audio (e.g., trimming, splicing etc. of audio tracks), bouncing audio, and so on. Examples of contemporary DAWs are:
Ableton Live
Logic Pro
Pro Tools
FL Studio
Cubase
Reason
GarageBand
Studio One
Bitwig Studio

Each of plugin 210 and 224 may independently be configured to communicate with REST API 216 and WebSocket API 218. In an aspect, WebSocket API 218 serves as a primary communication interface between plugins 210, 224 and backend 204, providing all real-time bidirectional communication capabilities. WebSocket API 218 operates on a designated port (e.g., port 10000) and implements a message-based protocol using JSON envelopes for all communications. The WebSocket API 218 supports the following core functionalities:

Session Management Operations: WebSocket API 218 enables plugins 210 and 224 to establish collaborative recording sessions through a “createsession” action. When plugin 210 (studio host) initiates a session, the system generates a unique 9-digit session identifier and studio connection identifier, persisting session metadata including community settings, project name, session name, and session description in a database. The system responds with confirmation data including the session ID and studio connection ID.

Client Connection Operations: Plugin 224 (client) joins existing sessions via a “joinsession” action, providing the session identifier and client name. The system validates session existence, assigns a unique numeric client ID, and broadcasts connection notifications to all participants including updated client lists. For community sessions, additional project metadata is returned to the joining client.

Audio Track Registration: Both plugins 210 and 224 can register audio tracks within a session using a “registertrack” action, specifying the session identifier and audio file URL. The system validates the session and URL parameters before persisting track information in the database.

Real-time Message Relay: WebSocket API 218 implements a comprehensive message routing system through a “sendmessage” action supporting three distinct communication modes: (1) client-to-client messaging, (2) studio-to-client messaging, and (3) client-to-studio messaging. Each message includes mode specification, target identification, session identifier, and message payload, with the system providing sender identification in delivered messages.

Connection Lifecycle Management: The system automatically handles connection terminations through internal disconnect procedures. When studio connections terminate, all session clients receive disconnect notifications, and the system performs cleanup operations including deletion of associated audio tracks from cloud storage and removal of session data. Client disconnections trigger similar notifications to remaining participants with updated client lists.

Message Protocol Structure: All WebSocket communications utilize standardized JSON envelopes with success responses formatted as {“code”: 200, “data”: <payload>} and error responses as {“code”: <error_code>, “data”: “<error_description>”}, providing consistent message handling across plugins 210 and 224.

Audio relay servers 212 and 226 may be configured to transmit and receive audio files (e.g., audio recordings in file formats such as MP3, AIFF, WAV, FLAC, ALAC, AAC, etc.), via cloud audio relay server 220. Web conference 214 and 228 may be configured to host a video call via video call 232. For example, a studio personnel working on studio host computer 202 and an artist working on client computer 206 may engage in a video call as a part of a collaborative audio recording session. Such a video call may be supported by a combination of web conference 214 and 228, and video call 232.

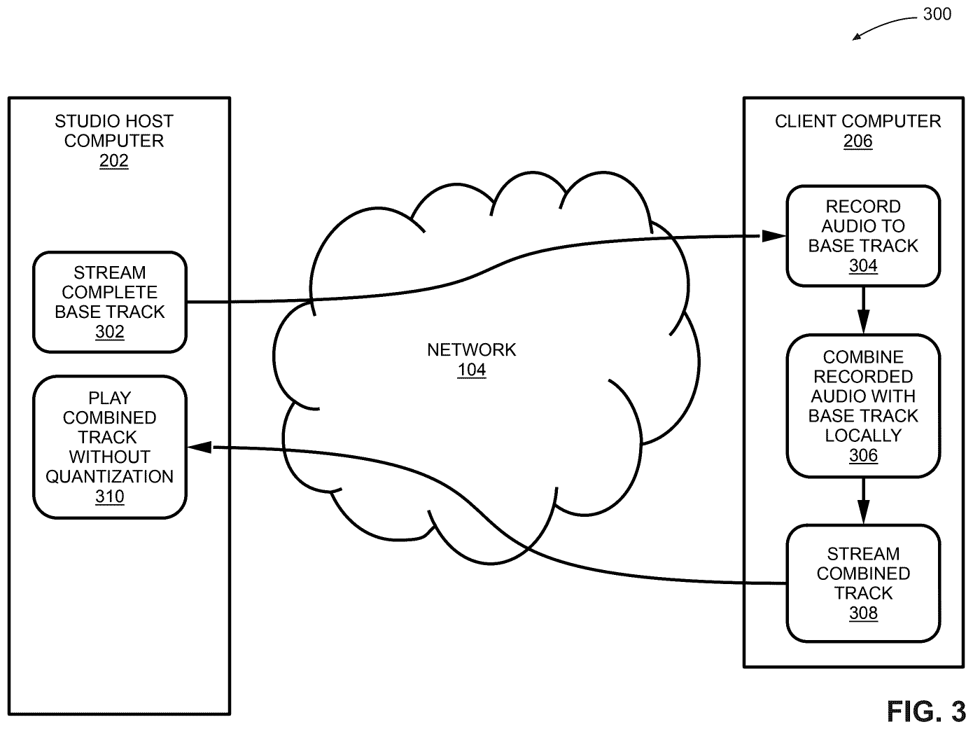

FIG. 3 is a block diagram depicting a workflow 300 associated with remote audio recording session 200. As depicted, studio host computer 202 may stream a complete base track over network 104 (302). For example, this base track may be streamed to cloud audio relay server 220 by audio relay server 212 over network 104. Client computer 206 may receive the base track via network 104. For example, audio relay server 226 may receive the base track from cloud audio relay server 220.

After receiving the base track, client computer 206 records audio to the base track (304). In other words, the client computer 206 records the audio track to be synchronous with the received base track. Client computer 206 may then combine the recorded audio track with the base track locally (306), to generate a combined audio track. The client computer 206 may stream the combined audio track over network 104 (308). For example, the combined audio track may be streamed by audio relay server 226 to cloud audio relay server 220 over network 104.

In an aspect, studio host computer 202 receives the combined audio track via network 104. For example, audio relay server 212 may receive the combined audio track from cloud audio relay server 220. The studio host computer 202 may then play the combined audio track without quantization (310). In other words, the combined audio track will not have any network 104—induced quantization errors between the base track and the recorded audio track. Essentially, by combining the base track with the recorded audio track, the remote audio recording system 200 ensures that any network delays associated with network 104 affects both the base track and the recorded audio track equally, resulting in both the base track and the recorded audio track being synchronized with each other. This functionality is an advancement over the prior art (e.g., over system 100).

### General Process Flow:

1. Studio (e.g., studio host computer 202) sends a full base track to client (e.g., client computer 206) (302).
2. Client (e.g., client computer 206) records to a local copy of the base track (304).
3. The client (e.g., client computer 206) combines the local audio recording with the base track in real-time (306) and streams the combined feed (combined audio track) to the studio (e.g., studio host computer 202) (308).
4. Studio (e.g., studio host computer 202) plays the combined feed with no desync (310).

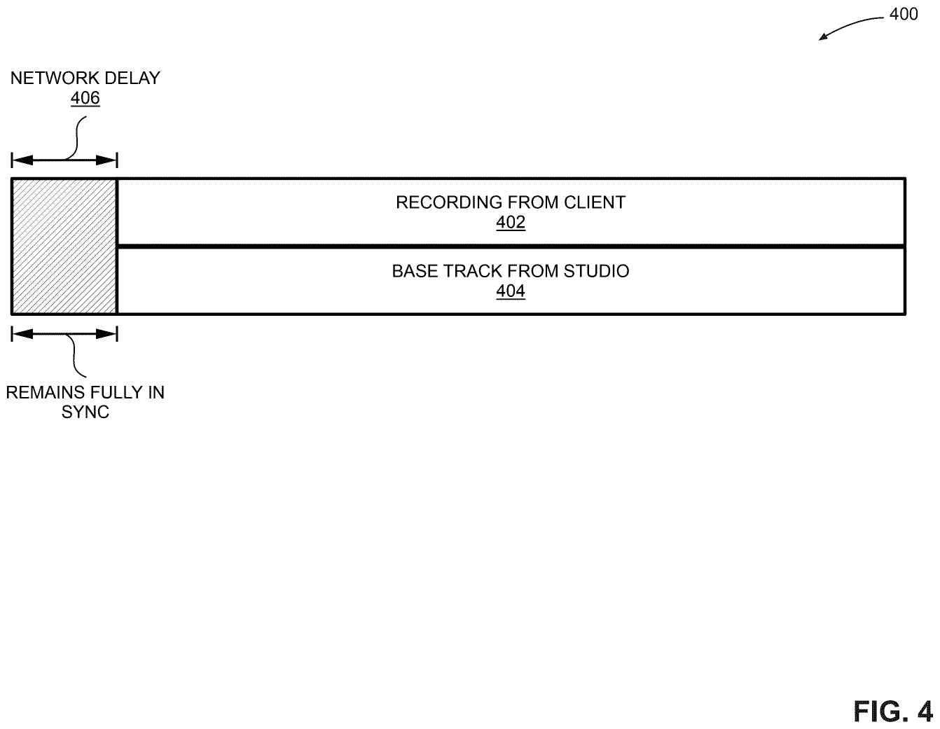

FIG. 4 is a timing diagram 400 showing a mitigation of the effects of network delay. As depicted, the recording from the client 402 (i.e., the audio track recorded to the base track at 304) is time-synchronized with the base track 404 from studio host computer 202, with both the recording from the client 402 and the base track 404 being subject to identical network delay 406. The combination of the recording from the client 402 and the base track 404 represents the combined recording (combined audio track) generated at 306.

### Augmented Zero Latency

In an aspect, the remote audio recording system 200 features an Augmented Zero Latency (AZL) concept. This approach seamlessly integrates multiple technologies to eliminate latency in remote recording sessions virtually, providing a real-time collaborative environment that mirrors the in-studio experience. One aspect includes a combination of cloud architecture, asynchronous coding, WebRTC, JUCE, and Tracktion Engine into a secure, scalable platform. This integration simplifies the remote recording process, saving time, and enhancing security.
1. Zero Latency (AZL) Definition: Augmented zero latency is a system that integrates cloud technology, asynchronous coding, real-time audio and video communication, and local recording into a secure, scalable platform to virtually eliminate delays in remote music recording, making it feel like all participants are in the same room.
2. Integrated Technologies: The remote audio recording system 200 creates a seamless and efficient recording environment by combining asynchronous coding, WebRTC for real-time audio and video routing, and secure cloud storage for data transfer.
3. User-Centric Design: The remote audio recording system 200 is designed with simplicity in mind. One aspect of remote audio recording system 200 features a minimalist interface with only four main buttons: Connect, Push, Record, and Bounce. This design ensures easy use for musicians and producers of all skill levels.
4. Real-Time Synchronization: The remote audio recording system 200 achieves real-time synchronization between studio and remote clients, ensuring that all collaborators are perfectly in sync regardless of their physical locations.
5. Automated Processes: Automating complex processes, such as reference track distribution and remote control of client applications, reduces setup time and minimizes potential errors.
6. Security: Advanced encryption methods for data at rest and in transit, combined with robust user authentication, protect intellectual property and ensure that only authorized users can access the system.

The remote audio recording system 200 integrates the above features into a cohesive, user-friendly platform that addresses the primary pain points of remote music recording-latency, synchronization, complexity, and security. The remote audio recording system 200 provides a solution that simplifies the recording process while maintaining professional standards, while being integrated into a secure, scalable platform.

The remote audio recording system 200 addresses perceived undesired outcomes and obstacles in remote recording. Traditional remote recording tools often fail to deliver the immediacy and quality of in-person sessions, leading to frustration and diminished creative output. The remote audio recording system 200 mitigates these concerns with its Augmented Zero Latency system, ensuring that musicians can achieve real-time collaboration without latency issues, preserving the natural flow and energy of the creative process.

The likelihood of achieving seamless remote recording with the remote audio recording system 200 is significantly higher than with other solutions, which often fall short due to technical limitations and compatibility issues. The remote audio recording system 200 platform's integration with various DAWs through both Audio Units (AUs) and VST3 plugins ensures that musicians can use their preferred tools without compromise. This universal integration eliminates the perceived obstacles of technology compatibility and workflow disruption, providing a seamless recording experience that aligns with professional standards.

Time delays in traditional remote recording setups, caused by latency and synchronization problems, can severely hinder the creative process. The remote audio recording system 200 addresses these issues by enabling real-time, synchronized collaboration through advanced cloud technology and asynchronous coding. The immediate transfer of recordings and the ability to control remote sessions from a central studio drastically reduces the time between effort and outcome. This efficiency not only saves valuable time for musicians and producers, but also enhances the overall productivity and quality of remote recording sessions. The result is a streamlined, efficient process that allows artists to focus on their creativity rather than technical challenges.

The remote audio recording system 200 integrates technologies such as cloud architecture, asynchronous coding, WebRTC, JUCE, and Tracktion Engine into a secure, scalable platform. This integration eliminates the delays traditionally associated with remote recording, creating a seamless, real-time collaborative environment replicating the in-studio experience.

Components that may be included in some embodiments of remote audio recording system 200 include:

JUCE: JUCE is a widely used open-source C++ audio application and plugin development framework. It allows developers to create standalone software on multiple platforms, including Windows, macOS, Linux, iOS, and Android. Additionally, JUCE supports the creation of audio plugins in various formats, including VST3, VST33, AU, AUv3, AAX, and LV2, making it highly versatile for cross-platform audio development. The flexibility and extensive support offered by JUCE ensure that the remote audio recording system 200 can operate seamlessly across different systems, providing a consistent user experience.

Tracktion Engine: Tracktion Engine is a high-level framework designed for time-based, sequenced audio applications. It provides an application programming interface (API) that allows developers to create, modify, and manage multiple edits, which are individual projects within the application. The Engine is responsible for playing back these edits, enabling efficient handling of complex audio arrangements. Developers can utilize a single Engine to manage and playback multiple Edits, making it a powerful tool for creating sophisticated audio applications.

WebRTC: WebRTC is a free and open-source project providing web browsers and mobile applications with real-time communication (RTC) via application programming interfaces (APIs). It supports audio and video communication and streaming inside web pages through direct peer-to-peer communication.

Amazon Web Services (AWS) S3: AWS S3 is a scalable and secure cloud storage service that manages large amounts of data generated during remote recording sessions. It offers high durability and availability for storing critical audio files, encryption for data at rest using AES-256, and secure data transfer using SSL/TLS. Aspects of backend 204 and server 230 may be implemented using AWS architecture.

### User Workflow:

### 1. User Authentication and Session Initiation

Users enter their credentials (username and password) to access the remote audio recording system 200 platform. The system verifies these credentials and establishes a secure session.
The studio initiates a session by pressing the “Connect” button on a graphical user interface displayed on studio host computer 202, generating a unique secure session identifier. This identifier is then emailed to the invited clients.

### 2. Establishing Connection

Clients receive the session identifier and use it to join the session by pressing the “Connect” button on a graphical user interface associated with an application running on client computer 206. The AWS API Gateway manages the secure connection, protecting the data transfer.

### 3. Pushing Reference Track

The studio presses the “Push” button on the graphical user interface of associated application to send a reference track to the client(s) (302). This track is uploaded to the AWS S3 bucket and then downloaded by the client application. This step ensures that all participants are synchronized.

### 4. Remote Recording

The studio remotely controls the client application using asynchronous coding. The “Record” button on the studio interface initiates recording on the client side. The client's audio is routed through WebRTC to the studio for real-time monitoring.
After recording, the audio file is transferred from the client to the AWS S3 bucket (cloud audio relay server 220) and downloaded to the studio system. The recorded track lands in the exact location on the timeline, ensuring perfect synchronization.

### 5. Bouncing Tracks

The “Bounce” button consolidates multiple audio recordings into a new reference track. This track replaces the individual recordings on the client system, optimizing resource utilization and maintaining a streamlined session structure.

### Security

The remote audio recording system 200 may employ advanced security measures to protect intellectual property and ensure safe data transfer, such as:
Encryption: Data at rest in AWS S3 is encrypted using AES-256. Data in transit is encrypted using SSL/TLS, ensuring secure communication between client and studio applications.
WebRTC Security: The remote audio recording system 200 uses Datagram Transport Layer Security (DTLS) for encryption and Secure Real-time Transport Protocol (SRTP) for secure media transmission.
User Authentication: Requires a username and password for access, ensuring only authorized users can join sessions.

### One-Touch Recording (Record Button)

The remote audio recording system 200 distinguishes itself through a user-centered design, emphasizing simplicity and ease of use. The core design principle revolves around being the “easy button” to recording and streamlining the music creation process for users of all levels of expertise. The (graphical) user interface incorporates a minimalist approach, featuring only four buttons. This intentional simplicity is an aesthetic choice and a strategic design to provide users with a straightforward and intuitive experience.

The remote audio recording system 200 features a seamless integration of user-centric design with powerful backend automation. While the interface may appear minimalistic, the backend processes are intricately automated to handle complexities efficiently. This approach ensures that users benefit from the sophistication of a professional recording platform without being overwhelmed by unnecessary intricacies.

The value proposition of the remote audio recording system 200 is epitomized by the effortless experience it delivers to musicians and collaborators. The four-button interface is an entry point to a world of possibilities, allowing users to focus on their creative expressions rather than navigating through many complex features. The user-centered design not only promotes accessibility for beginners but also caters to seasoned professionals looking for a streamlined and efficient recording solution.

The remote audio recording system 200 value stems from its commitment to making the recording process accessible and enjoyable. The platform democratizes music creation by embodying the “easy button” philosophy, enabling users to unleash their creativity effortlessly. The combination of a minimalist interface and robust backend automation exemplifies the philosophy of the remote audio recording system 200 to providing a user-friendly yet powerful recording experience for musicians worldwide.

### Advantages

The remote audio recording system 200 provides the following advantages:
Time Savings: The remote audio recording system 200 reduces setup and recording time by approximately 50% by automating complex processes and ensuring real-time synchronization. This is based on internal testing and user feedback, indicating that sessions typically take several hours can be completed in half the time.
Cost Savings: Eliminating the need for physical studio space and travel reduces costs by up to 60%. For instance, a typical studio session costing $500 per hour can be reduced to $200 per hour with the remote audio recording system 200, considering the saved logistics and studio rental expenses.

### Key Technologies

### Cloud Architecture

Amazon Web Services (AWS) S3: AWS S3 provides scalable and secure cloud storage essential for managing the vast amounts of data generated during remote recording sessions. It ensures that all recorded tracks are securely stored and easily accessible. The service offers high durability and availability, making it an ideal solution for storing critical audio files.
AWS API Gateway: The AWS API Gateway acts as a bridge between the client and studio applications, facilitating secure and efficient communication. It enables the seamless transfer of data and ensures that all interactions between the client and server are managed securely and reliably.

### Asynchronous Coding

Asynchronous coding is implemented in the remote audio recording system 200, allowing tasks to run independently and concurrently. Asynchronous coding ensures that the system can handle real-time operations, such as remote control of the client application and immediate data synchronization, without causing delays or interruptions. The remote audio recording system 200 provides a responsive and smooth user experience by leveraging asynchronous coding, crucial for professional-grade remote recording.

### WebRTC

WebRTC (Web Real-Time Communication): WebRTC is a powerful technology that enables real-time audio and video communication between studio and remote clients. It allows for direct peer-to-peer connections, ensuring low latency and high-quality audio and video streams. WebRTC uses Datagram Transport Layer Security (DTLS) for encryption and Secure Real-time Transport Protocol (SRTP) for secure media transmission, ensuring all communications are protected from unauthorized access.

### JUCE

JUCE is a comprehensive framework for developing audio applications and plugins. It supports the creation of standalone software and plugins for various platforms, including Windows, macOS, Linux, iOS, and Android. JUCE simplifies the development process by handling differences between operating systems and plugin formats, allowing developers to focus on the core functionality of their software. Its digital signal processing (DSP) building blocks are essential for quickly prototyping and releasing high-quality audio applications.

### Tracktion Engine

The Tracktion Engine is a high-level document object model for time-based, sequenced audio applications. It provides an API for creating, modifying, and playing back audio tracks. By defining an arrangement object called an Edit, Tracktion Engine allows users to add elements such as audio files, MIDI, and plugins, then play them back or render them to an audio file. This engine is crucial for managing the complex arrangements and edits required in professional music production.

### Standalone Application

This application serves as the primary interface for users and is designed with simplicity and efficiency in mind. It features a minimalist graphical user interface with only four main buttons-Connect, Push, Record, and Bounce-allowing users to focus on their creative work without being overwhelmed by complex controls. The standalone application integrates seamlessly with various DAWs, ensuring compatibility and ease of use across different platforms.

These key technologies collectively contribute to the capabilities of the remote audio recording system 200, enabling the implementation of a seamless, real-time remote recording experience that is both secure and efficient. By integrating these advanced technologies into a cohesive platform, the remote audio recording system 200 addresses the primary challenges of remote music production, setting a new standard in the industry.

### Security Measures

### Data Encryption

AWS S3 Encryption: One embodiment of the remote audio recording system 200 utilizes AWS S3 to store audio files and other critical data securely. Data stored in S3 is encrypted at rest using AES-256 encryption, a robust encryption standard that ensures data confidentiality and integrity. This encryption prevents unauthorized access to stored files, protecting intellectual property.
Data in Transit: In one aspect, the remote audio recording system 200 employs SSL/TLS encryption to secure data during transmission. This ensures that all data transferred between the client and studio applications and between the AWS infrastructure is encrypted and protected from interception or tampering by unauthorized parties.

### WebRTC Security

Datagram Transport Layer Security (DTLS): WebRTC uses DTLS to encrypt data channels. DTLS is a protocol designed to provide security for datagram-based applications by preventing eavesdropping, tampering, and message forgery. This ensures that all real-time audio and video communications are secure.
Secure Real-time Transport Protocol (SRTP): WebRTC also employs SRTP to provide encryption, message authentication, and integrity for the media streams. SRTP ensures that audio and video data transmitted during a recording session is protected from unauthorized access and tampering.

### User Authentication

Username and Password: In an aspect, the remote audio recording system 200 requires users to authenticate using a username and password. This authentication mechanism ensures only authorized users can access the platform and participate in recording sessions. By requiring credentials, the remote audio recording system 200 adds a layer of security that protects against unauthorized access.

### Session Security

Unique Session Identifiers: When a recording session is initiated, the remote audio recording system 200 generates a unique identifier that is securely communicated to invited participants via email. Using unique session identifiers ensures that only those with explicit permission can join and participate in the session.

### Access Control

Role-Based Access: An embodiment of the remote audio recording system 200 implements role-based access control to manage permissions and ensure users have appropriate access to features based on their roles. For example, a studio engineer may control the recording process, while a session musician may only have access to their recording controls.

### Intellectual Property Protection

Secure Cloud Storage: One embodiment of the remote audio recording system 200 uses AWS S3 to store all recorded tracks and session data securely. AWS S3's durability and availability features, combined with its encryption capabilities, provide a secure repository for sensitive audio files, protecting them from loss and unauthorized access.
Real-Time Monitoring and Control: WebRTC for real-time audio and video routing allows studio engineers to monitor and control recording sessions as they happen. This capability helps prevent unauthorized recording and ensures all participants adhere to the session's security protocols.

These comprehensive security measures ensure that the remote audio recording system 200 provides a secure environment for remote music recording, protecting intellectual property and maintaining the integrity and confidentiality of all recorded data. By integrating these advanced security technologies, the remote audio recording system 200 offers a reliable and trustworthy solution for professional remote music production.

### Technical Description of Various Components of the Remote Audio Recording System 200

### JUCE

Overview: JUCE is a widely used audio application and plugin development framework. Its open-source C++ codebase supports the creation of standalone software on multiple platforms and various plugin formats.
Capabilities: JUCE handles operating system and plugin format differences, allowing developers to focus on core functionalities. It includes a library of digital audio processing/DSP building blocks to quickly prototype and release native applications and plugins with a consistent user experience across all supported platforms.

### Tracktion Engine

Overview: Tracktion Engine defines a high-level document object model for time-based, sequenced audio applications and provides an API for creating, modifying, and playing back these sequences.
Capabilities: Tracktion Engine enables the creation of an Engine object, called an Edit, where users can add audio files, MIDI, and plugins, and then play them back or render them to an audio file. It is designed in a JUCE module format for quick setup and project creation.

### WebRTC

Overview: WebRTC is a free and open-source project providing web browsers and mobile applications with real-time communication (RTC) via application programming interfaces (APIs). It supports audio and video communication and streaming inside web pages through direct peer-to-peer communication.
Capabilities: WebRTC includes audio and video data support, data channels for arbitrary data transfer, and encryption protocols like DTLS and SRTP for secure communication.

### AWS S3

Overview: Amazon Web Services (AWS) S3 is a scalable and secure cloud storage service used to manage large amounts of data generated during remote recording sessions.
Capabilities: AWS S3 offers high durability and availability for storing critical audio files, encryption for data at rest using AES-256, and secure data transfer using SSL/TLS.

### AWS API Gateway

Overview: AWS API Gateway is a fully-managed service that makes it easy for developers to create, publish, maintain, monitor, and secure APIs at any scale.
Capabilities: The AWS API Gateway routes requests between the client and studio applications, ensuring secure and efficient communication. It supports various communication protocols, including HTTP and WebSocket.

### Standalone Application

Overview: The standalone application associated with the remote audio recording system 200 is designed for simplicity and efficiency and serves as the primary interface for users. It features a minimalist graphical user interface with four main buttons: Connect, Push, Record, and Bounce. The standalone application may be implemented on any or both of studio host computer 202 and client computer 206.
Capabilities: This application integrates seamlessly with various DAWs, ensuring compatibility and ease of use. It focuses on providing an intuitive user experience while automating the backend complexities.

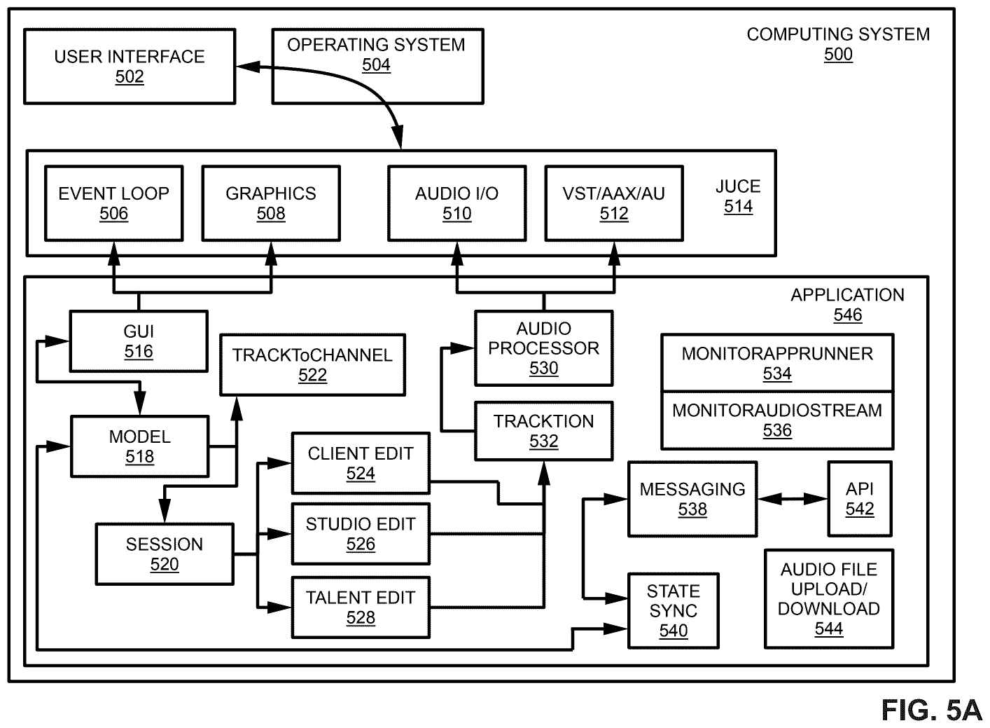

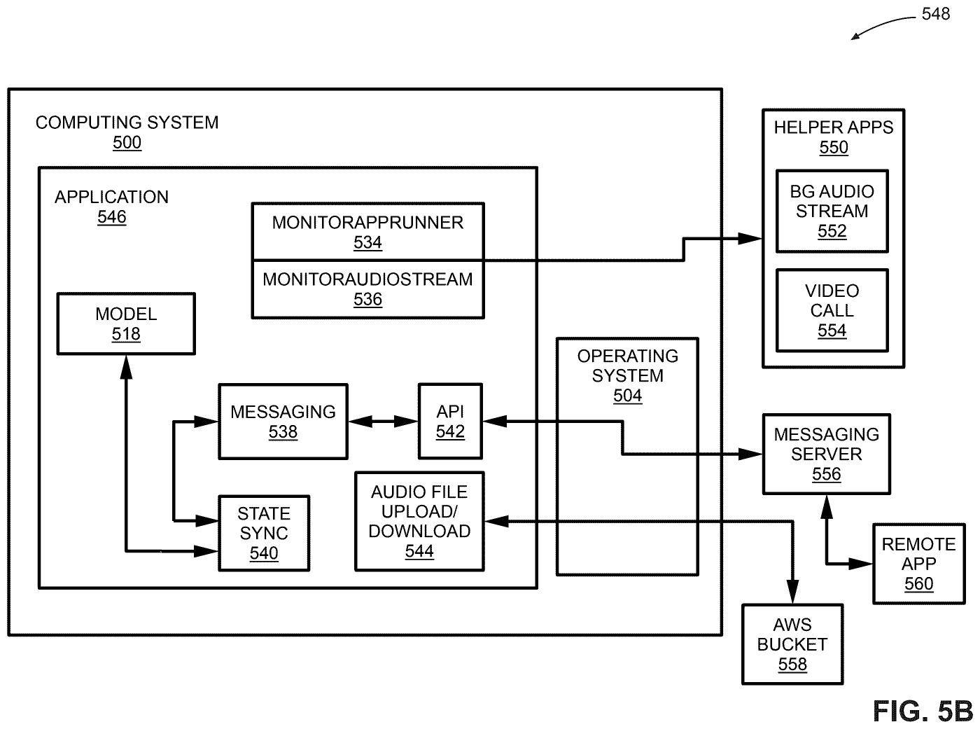

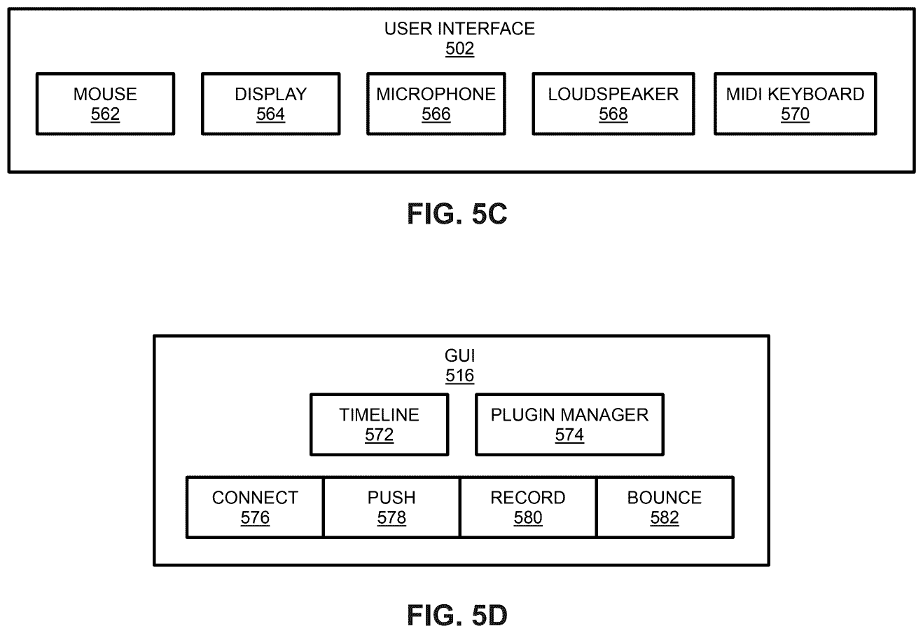

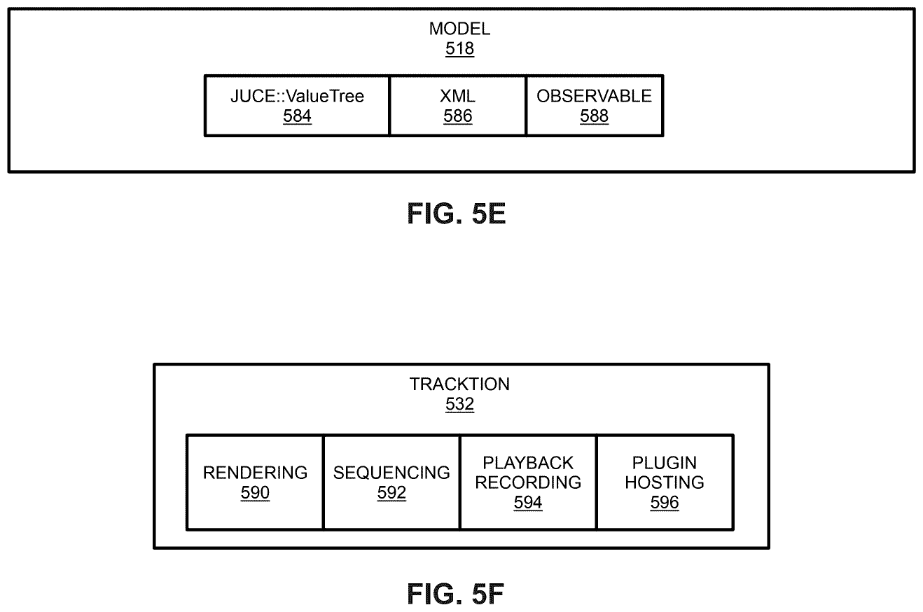

FIGS. 5A-5F are block diagrams depicting different components of a computing system 500. In an aspect, computing system 500 may be used to implement aspects of any combination of studio host computer 202 and client computer 206.

Referring to FIG. 5A, computing system 500 includes user interface 502, operating system 504, JUCE 514, and application 546. JUCE 514 further includes event loop 506, graphics 508, audio I/O 510, and VST/AAX/AU 512. Application 546 further includes graphical user interface (GUI) 516, model 518, session 520, TrackToChannel 522, client edit 524, studio edit 526, talent edit 528, audio processor 530, Tracktion Engine 532, monitor app runner 534, monitor audio stream 536, messaging 538, application programming interface (API) 542, state sync 540, and audio file upload/download 544.

Referring to FIG. 5C, user interface 502 further includes mouse 562 (which, in some embodiments refers to/includes a mouse and a keyboard), display 564, microphone 566, loudspeaker 568, and MIDI keyboard 570. In an aspect, mouse 562 acts as a human-machine interface device to enable a user to interact with computing system 500. Display 564 may be used to present a graphical user interface (e.g., GUI 516) to the user. Microphone 566 may be used to record audio (e.g., to a base track on studio host computer 202 or to an audio track on client computer 206), or engage in a video call with a party on the other computer. Loudspeaker 568 may be used to play back recorded or received audio, as well as for audio output during the video call. User interface 502 may also include a camera (not shown in FIG. 5C) to further support the video call.

In an aspect, MIDI keyboard 570 may be plugged in to computing system 500 to interface with DAW 208 or 222. MIDI keyboard 570 enables a user to play and record audio on computing system via the DAW. MIDI keyboard 570 may be used by a user on either studio host computer 202 or client computer 206 to record audio (music) on the respective computing system.

As depicted in FIG. 5A, a user interacts with different components of computing system 500 via user interface 502, with user interface commands and data being routed via operating system 504. Operating system 504 may be an operating system running on computing system 500, such as Android, IOS, Linux, MacOS, Windows, etc.

### Tracktion Engine 532

The Tracktion framework/engine 532 is used for audio processing and sequencing. It is built using the JUCE framework. Because application 546 closely integrates with Tracktion, it also extends Tracktion's model design. The Tracktion engine 532 provides most of the technical aspects of the audio engine of the remote audio recording system 200, including the timeline, audio clips, audio and midi tracks, arming and input monitoring, recording, rendering, mute and solo, time and beat conversion, and transport.

### JUCE 514

In an embodiment of computing system 500, JUCE 514 forms a base for application 546. Application 546 maybe an embodiment of the standalone application described above. In an aspect, JUCE 514 provides the application entry point (i.e., an interface between user interface 502 and application 546, via operating system 504), the main event loop 506, and the audio callback for both the standalone application and the plugins (i.e., audio I/O 510 and plugins such as VST/AAX/AU 512). JUCE 514 is also used for all graphics 508. Another aspect of JUCE is its multi-platform support, making it very easy to leverage operating system (OS)-specific functions without implementing them all separately. In this way, JUCE 514 provides an abstraction layer between app code (i.e., application 546) and user input and output (i.e., user interface 502). In remote audio recording system 200, all mouse and keyboard input, display monitors, audio drivers, and MIDI input are all provided by JUCE 514 directly.

### Model 518

Referring to FIG. 5E, an aspect of application 546 includes a Model-View-Controller (MVC) design. One aspect of the remote audio recording system 200 is model 518. The model is built up primarily around the JUCE::ValueTree class 584. This makes integrating with the Tracktion engine 532 easier as its model is also designed around the JUCE::ValueTree 584. The JUCE::ValueTree 584 is associated with an observable tree structure 588 that can hold free-form data and is serializable to XML 586, amongst other things. Updating the user interface (UI) 502 and audio pipeline (e.g., audio processor 530 and audio I/O 510) and synchronizing the state between client computer 206 and studio host computer 202 are all automated through the observable pattern of the JUCE::ValueTree 584. The observer handles many stateful updates asynchronously to optimize messages and ensure that the UI 502 always stays responsive.

### Session 520 and Edits 524, 526 and 528

A user can start a single session 520 in which the user creates either a client edit 524 or a studio edit 526, from client computer 206 or studio host computer 202, respectively. An edit is an extension of the Tracktion::Edit class, with additional functionalities supporting the capabilities of remote audio recording system 200. Whenever a change in the state is made through the UI 502 or via messaging, the edit is updated, which automatically causes an update in the Tracktion engine. For example, the track and clip sequencing, playback and recording, and processing of hosted audio plugins. While a client session always has a single client edit 524, the studio edit is more complicated. When a studio session is started, a main studio edit 526 is created, and an additional talent edit 528 is created for each client that joins. This talent edit 528 is kept in sync with the matching client edit 524 using state synchronization 540 over the network.

### TrackToChannel 522

When plugin 210 or 224 is loaded in a respective DAW, a particular mode called TrackToChannel 522 can also be selected instead of a session. Another instance should already be running a session for this mode to work. In the TrackToChannel 522 mode, the plugin instance will play back only a single track from the existing session from the other plugin instance. This can be used with the DAW mixer instead of the instance associated with application 546.

### GUI 516

In an aspect, a session (e.g., session 520) can be created or joined from the UI 502 by clicking a CONNECT button 576 displayed on display 564 by GUI 516 (depicted in FIG. 5D). A list of community sessions is available to select from as well. Referring to FIG. 5D, a main view rendered on display 546 by GUI 516 shows a timeline 572 and controls for a single edit. In the case of the client computer 206, this is always the main edit. A studio user working on studio host computer 202 can select which edit to display—the main studio edit 524 or one of the talent edits 528. With the PUSH button 578, the studio user can send a reference track to all clients working on a respective client computer 206. The studio user working on studio host computer 202 can start a recording for a client computer 206 by clicking the RECORD button 580 displayed on display 564 by GUI 516. Finally, whenever the studio user decides it is necessary, the mix can be bounced into a single audio file using the BOUNCE button 582, which is then used as the new reference track. The GUI 516 also provides a plugin manager 574 to manage external audio plugins.

### State Synchronization 540 and Messaging 538

Referring to FIGS. 5A, 5B and 5E, when properties in model 518 change, a controller (e.g., messaging 538) that observes the model 518 (e.g., using observable 588) handles sending the messages needed for state synchronization 540. The controller analyzes whether it is a supported property and whether it should be kept in sync 540 and then, if necessary, applies stateful modifications to the property. A specific message for the given state change is then constructed and sent through API 542 to the messaging server 556. This message includes whether it was sent from a client or studio and for which client it is intended, if applicable. The message server 556 analyzes which client/studio to send the message to and forwards it to, for example a remote app 560 running on the associated studio host computer 202 or client computer 206. This forwarding operation may be performed via operating system 504.

On the receiving end, the message is handled in the controller class, which applies additional state modifications if necessary and then directly updates the model 518. For example, when a track is created in a talent edit 528, a child Value Tree 584 is added to a state of model 518. The controller then constructs a TrackAddedMessage and sends it to the message server 566 via messaging 538 and API 542, with the client computer 206 as its target recipient. Upon receiving the TrackAddedMessage (e.g., via operating system 504), the client controller constructs a new Tracktion Track and adds it to its model 518.

### Audio File Upload/Download 544

A particular case of state synchronization 540 is the uploading and downloading audio tracks 544. Whenever an audio track change happens in the model 518, the audio file associated with the audio track is automatically uploaded to AWS (AWS bucket 558) on a background thread job, via operating system 504. The client computer 206, at this point, already has received the ID for the audio track in question and is waiting for it to become available for downloading. When available, the download starts to a local file, and the downloaded file finally replaces the file reference in the respective model 518. The controller also initiates the downloading and uploading of audio files.

### Helper Apps 550

In an aspect, application 546 has two helper apps 550—background audio stream 552 and video call 554. When a session starts, the video call 554 app is automatically launched through the MonitorAppRunner 534 and then receives the necessary session information to auto-configure the video call environment (e.g., via web conference 214 and 228, and video call 232). Starting a session also creates a MonitorAudioStream 536 that starts a local network audio stream (i.e., background audio stream 552) for the app's audio output. The video call 554 receives this audio stream 552 and adds it to the video call stream so that the real-time audio output is also transmitted through the video call.

### Tracktion 532

Tracktion 532 is an open-source C++ library that may be used to implement of multiple parts of an audio engine (e.g., audio processor 530). In an aspect, Tracktion 532 builds up an internal audio graph based on a configured application XML's based JUCE::ValueTree model (e.g., JUCE::ValueTree 584), defining a state about tracks, clips and audio files. Tracktion 532 may also use JUCE to perform various tasks such audio I/O, MIDI handling, and various utility tasks such as file reading and writing. In an aspect, Tracktion 532 includes the following components

### Rendering 590:

Tracktion is capable of rendering 590 a Tracktion project, by converting audio associated with the project to an audio file. Tracktion 532 takes the configured project model, and performs an offline render when requested.

### Sequencing 592:

Tracktion 532 organizes audio and MIDI clips on a timeline, playing them back at the right time. This functionality is referred to as sequencing 532. In an aspect, the underlying ValueTree model can be modified to move audio and MIDI files to the desired locations. Internally, Tracktion 532 keeps track of the current play location with an internal playhead. Through a centralized ValueTree model, a User Interface can show a user what the timeline looks like, allowing the user to modify the timeline, essentially modifying the underlying model.

### Playback and Recording 594:

Tracktion 532 performs playback and recording 594 by reading audio input and writing audio output. To perform playback and recording 594, Tracktion 532 makes use of JUCE to perform low-level operations such as connecting to an audio interface.

### Plugin Hosting 596:

Tracktion plugin hosting 596 is used to host one or more plugins (e.g., plugins 210 and 224). To accomplish this, Tracktion 532 may use JUCE, while extending this wrapping the JUCE hosted plug-in within the Tracktion eco-system.

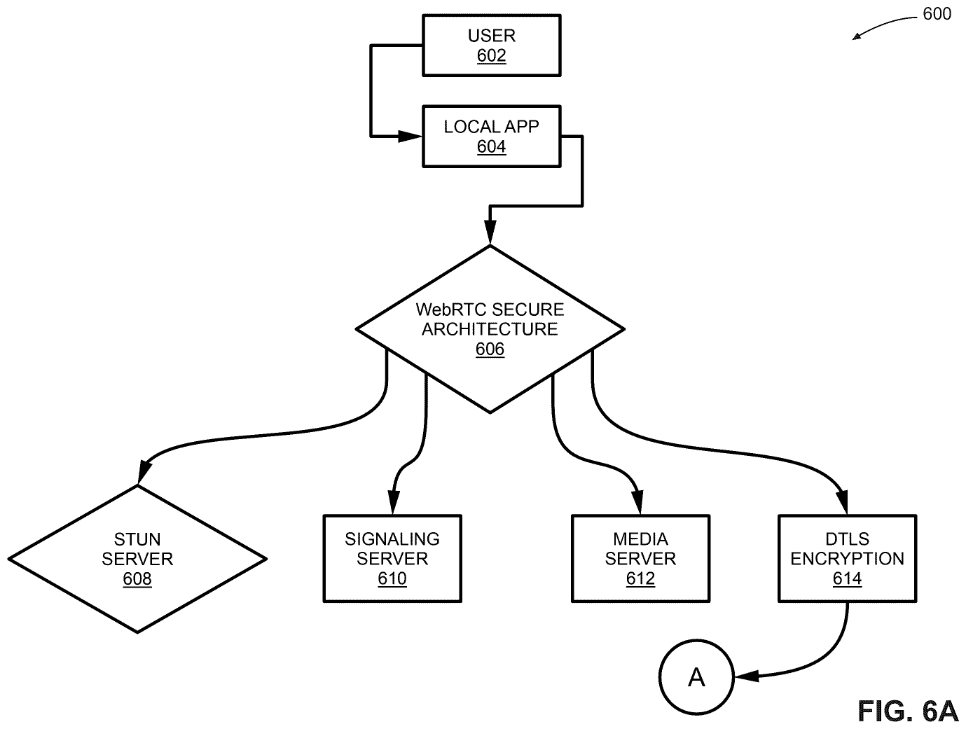

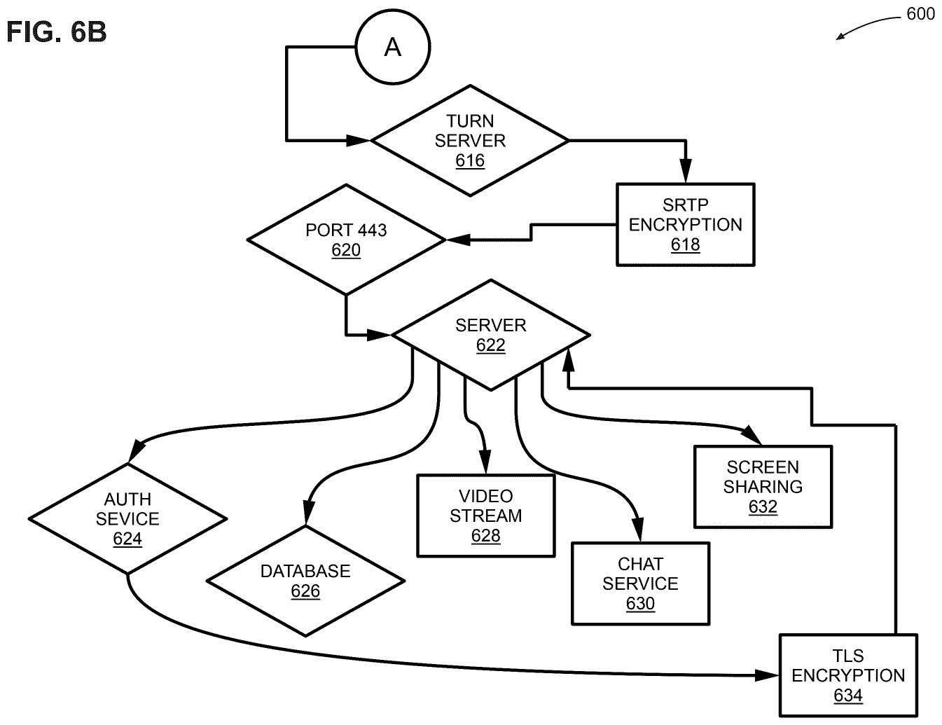

FIGS. 6A-6B are flow diagrams depicting an interconnectivity 600 between different components associated with remote audio recording system 200. The interconnectivity 600 shows how WebRTC is utilized for real-time audio and video communication, allowing studio engineers to monitor and control the recording sessions.

As depicted, user 602 logs in via local app 604 (installed on either of studio host computer 202 or client computer 206), which communicates with WebRTC secure architecture 606. WebRTC secure architecture 606 is further communicatively coupled with STUN server 608, signaling server 610, media server 612, and DTLS encryption 614 (FIG. 6A).

Referring to FIG. 6B, DTLS encryption is further communicatively coupled with TURN server 616, which implements SRTP encryption 618. An output of SRTP encryption 618 is transmitted to server 622 via port 443 620. Server 22 is further configured to connect to authentication service 624. Authentication service 624 may be configured to provide authentication via TLS encryption 634, back to server 622. In an aspect, server 622 is connected to database 626, video stream 628, and chat service 630. Server 622 may also be configured to provide screen sharing 632.

The interconnectivity 600 may include the following components:
WebRTC Peer-to-Peer Connections (606)
Real-Time Audio and Video Streams (628, 632)
Studio Monitor Interface
Security Protocols (DTLS 614, SRTP 618)

In an aspect, the TURN (Traversal Using Relays around NAT) 616 server enables WebRTC applications to work seamlessly across network environments, especially NAT and firewalls. The TURN server 616 may be associated with the following functionality:

### 1. Relay Role:

When direct peer-to-peer connections are not established (often due to NAT/firewall restrictions), the TURN server 616 acts as an intermediary relay.
The TURN server 616 receives media traffic from one peer and forwards it to the other, ensuring the communication can proceed despite network obstacles.

### 2. Session Establishment:

During the initial connection setup, the Interactive Connectivity Establishment (ICE) framework is used to determine the best path for communication.
If ICE detects a direct connection is impossible, it will switch to using the TURN server 616 as a relay.

### 3. Media Relay:

Once established, all media traffic (audio, video, data) between the peers is relayed through the TURN server 616.
This ensures communication can continue without interruption, even in restrictive network conditions.

### Types of Encryption for Remote Audio Recording System 200

### 1. DTLS (Datagram Transport Layer Security) 614:

DTLS encrypts the data transported between the peers and the TURN server 616.
It provides privacy, integrity, and authenticity of the messages, ensuring that unauthorized parties cannot tamper with or intercept the data.

### 2. SRTP (Secure Real-Time Transport Protocol) 618:

SRTP encrypts the media streams (audio and video) transmitted over the network.
It ensures the confidentiality and integrity of the media content, preventing eavesdropping and tampering.

### 3. TLS (Transport Layer Security) 634:

TLS secures the communication between client applications and the signaling server for signaling and control messages.
This protects the setup and management of the WebRTC sessions from being compromised.

### WebRTC Real-Time Communication Architecture

The remote audio recording system 200 implements a WebRTC (Web Real-Time Communication) architecture 606 to enable secure, low-latency audio and video communication between studio host computer 202 and client computer 206. The WebRTC architecture 606 comprises several interconnected components that facilitate real-time media transmission and signaling coordination.

The WebRTC implementation utilizes a STUN (Session Traversal Utilities for NAT) server 608 configured to discover public-reflexive candidates via NAT bindings, operating on port 3478/UDP without media relay functionality.

A signaling server 610 manages application-specific message routing through WebSocket connections, handling RTC-specific actions including: RTC-offer messages containing SDP offers from studio to client, RTC-answer messages containing SDP answers from client to studio, RTC-candidate messages for ICE candidate exchange in either direction, and session management messages for participant presence and cleanup operations.

The system provides integrated chat services 630 through WebSocket messaging for reliable, persistent communication. Screen sharing 632 functionality is implemented using getDisplayMedia API calls, supporting capture of screen, window, or browser tab content with system audio inclusion where supported by the client platform.

In an aspect, server 622 is a component of interconnectivity 600 that enables/is associated with authentication service 624, database 626, video stream 628, and chat service 630, screen sharing 632. Port 443 620 is presented to specify a port used for an https protocol.

In as aspect, database stores 626 the list of alpha signups, a list of active clients, real-time logs, created sessions with their accompanying metadata, uploaded track ids (to then pull from cloud storage), the metadata for created user accounts, and the encrypted auth information for the user accounts. Video stream 628 may be configured as an application that uses WebRTC to facilitate a peer-to-peer video call between connected clients, using TURN server 616.

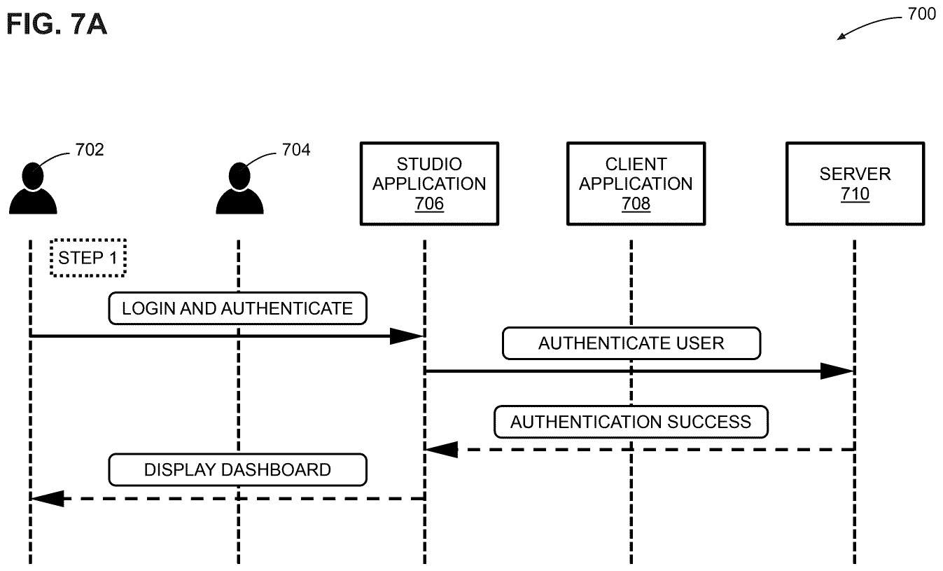

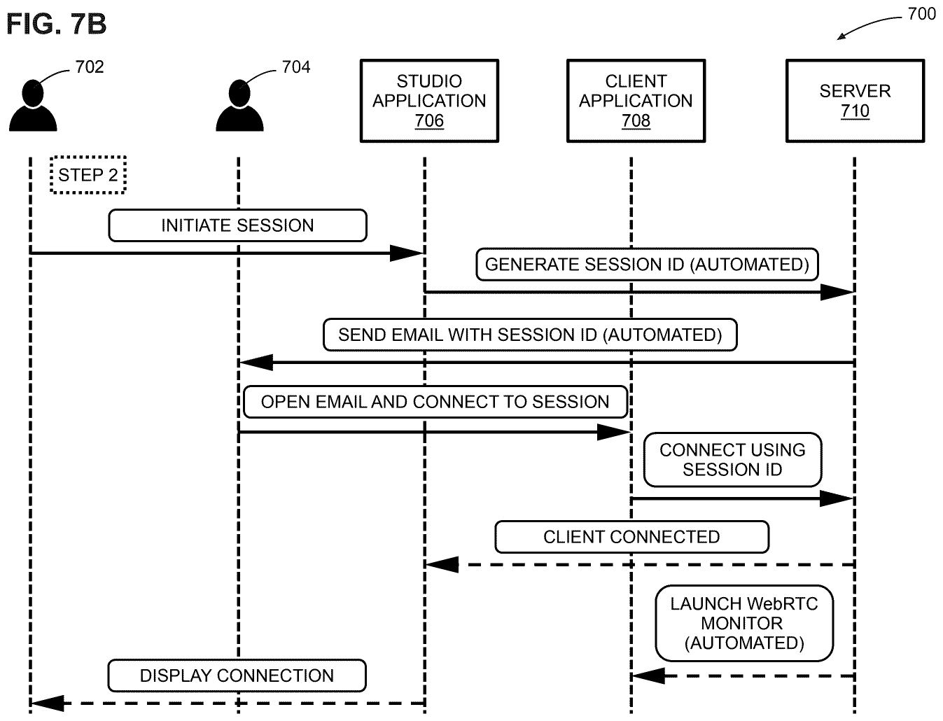

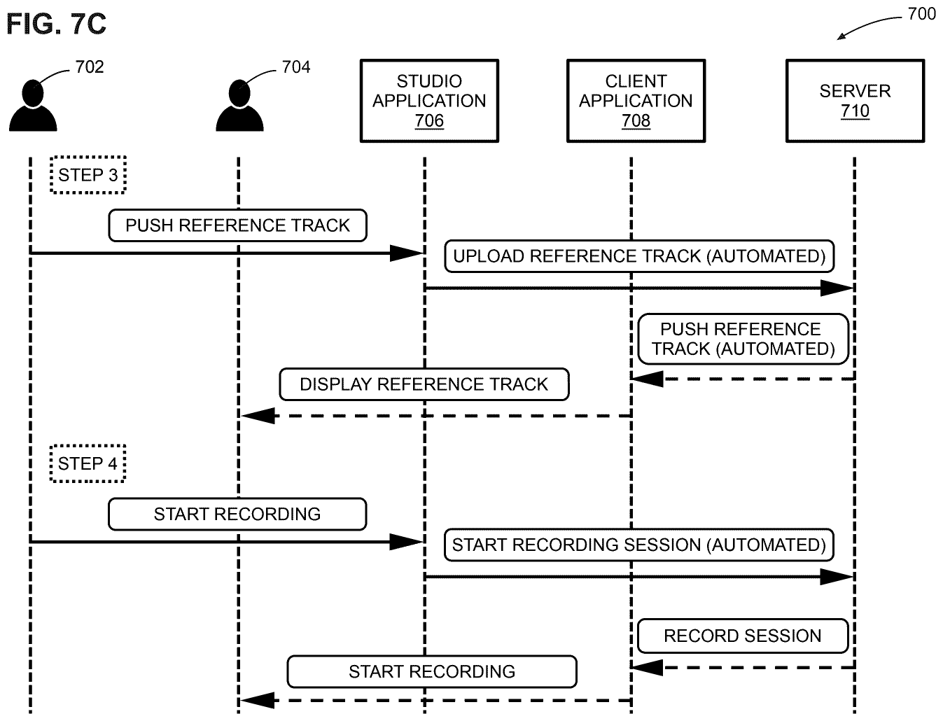

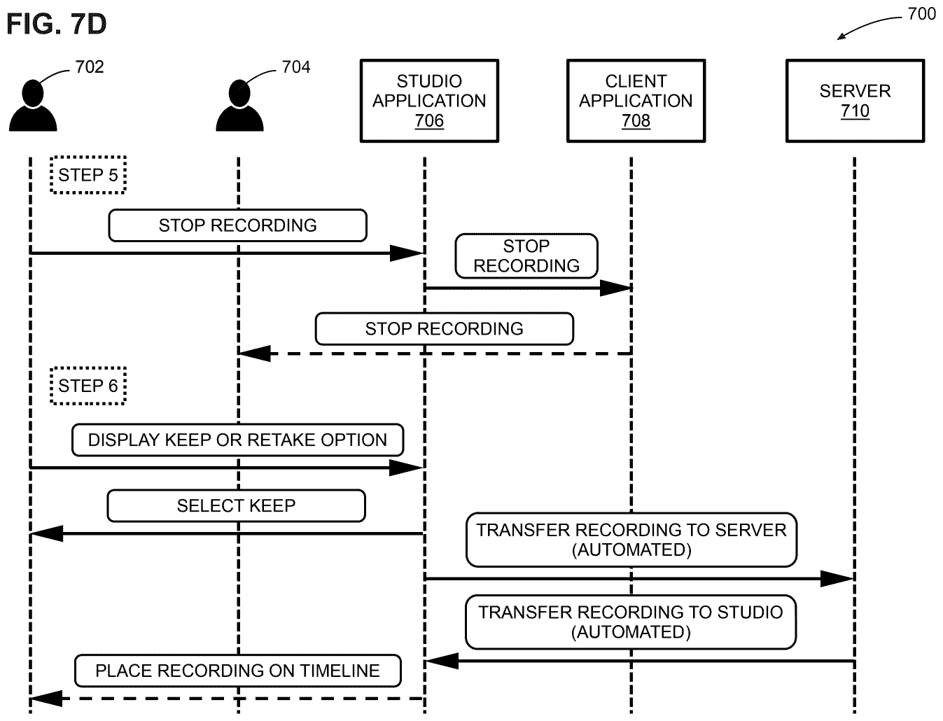

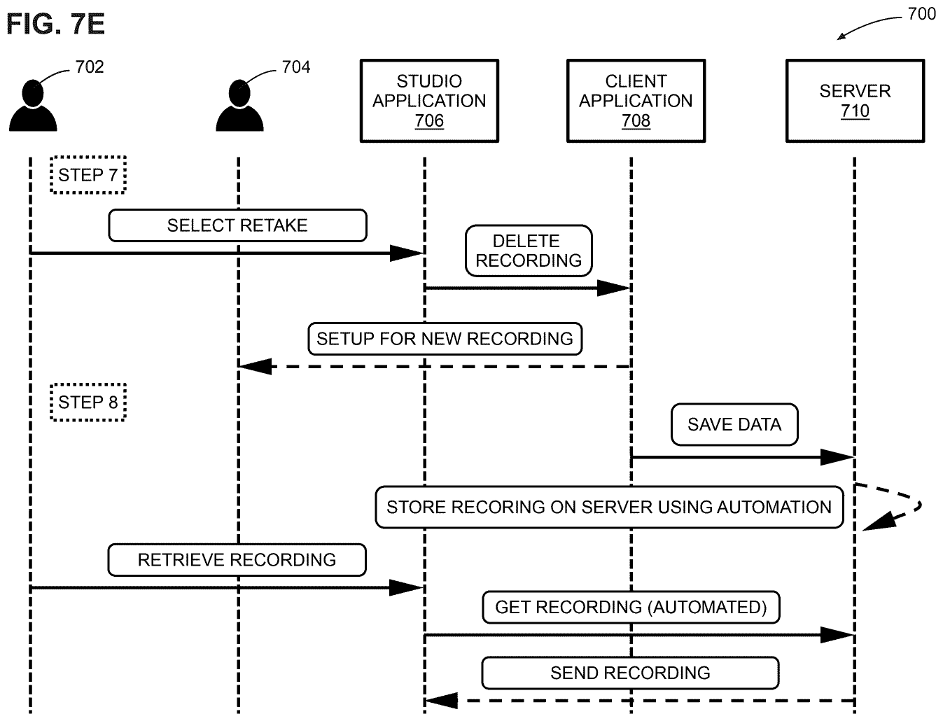

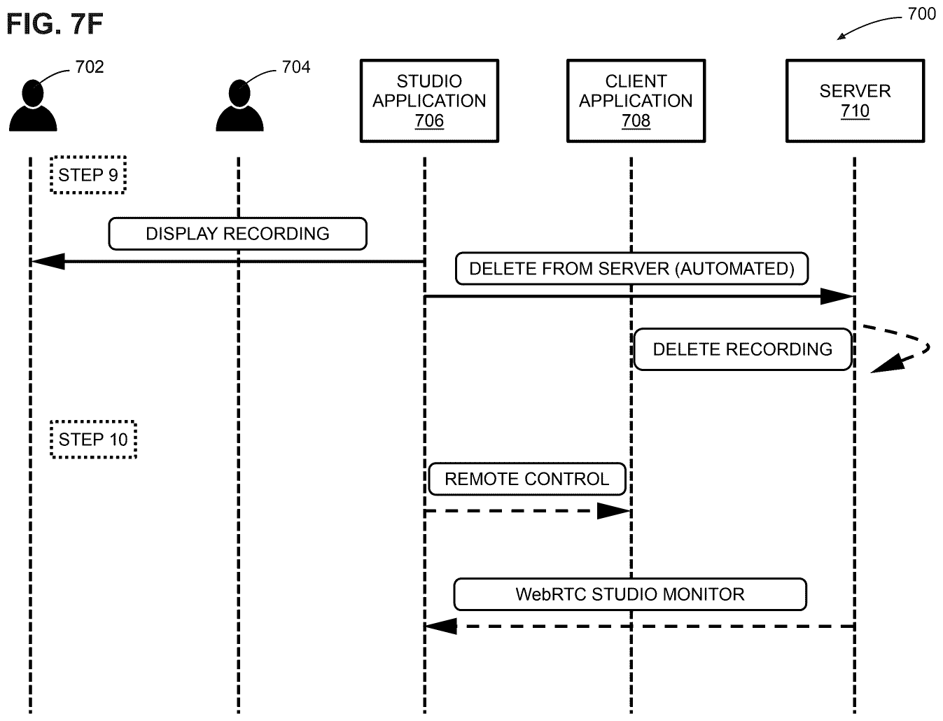

FIGS. 7A-7F are process flow diagrams depicting a remote audio recording session 700. As depicted, remote audio recording session 700 may be associated with remote audio recording system 200. Remote audio recording session 700 may be enabled by studio user 702 logging on to studio application 706 on studio host computer 202, client user 704 logging onto client application 708 on client computer 206, and server 710. Each of studio application 706 and client application 708 may be a variant of application 546.

Referring now to FIG. 7A, a step 1 associated with remote audio recording session 700 includes the following sequence of operations:
Studio user 702 is logged in and authenticated on studio application 706. The user authentication may be achieved via communication between studio application 706 and server 710 (e.g., via network 104).
The server 710 may return an authentication success status.
A dashboard (e.g., rendered by GUI 516 on display 564 of studio host computer 202) may be displayed to studio user 702.

Referring now to FIG. 7B, a step 2 associated with remote audio recording session 700 includes the following sequence of operations:
A session is initiated for the studio user 702 on studio application 706.
The studio application 706 communicates with server 710 to automatically generate a session ID.
The server 710 may automatically send the session ID to client user 704 (e.g., via an email).
The client user 704 may open the email and connect to the session using the client application 708.
The client application 708 uses the session ID to connect to the session by communicating with server 710.
The server 710 may confirm the client connection to studio application 706.
The server 710 may automatically launch a WebRTC monitor on client application 708.
The studio application 706 may display the connection to studio user 702.

Referring now to FIG. 7C, a step 3 associated with remote audio recording session 700 includes the following sequence of operations:
Studio user 702 may push a reference track via studio application 706. In an aspect, studio user 702 may perform this push operation by pressing the PUSH button 578 displayed on GUI 516.
In response, studio application 706 automatically uploads the reference track to server 710.
Server 710 may automatically push the reference track to client application 708.
Client application 708 then displays the reference track to client user 704.

Referring again to FIG. 7C, a step 4 associated with remote audio recording session 700 includes the following sequence of operations:
Studio user 702 may start a recording via studio application 706. In an aspect, studio user 702 may perform this recording operation by pressing the RECORD button 580 displayed on GUI 516.
In response, studio application 706 communicates with server 710 to automatically start the recording section.
The server 710 starts a recording session on client application 708.
The client application 708 displays a recording status to client user 704.

Referring now to FIG. 7D, a step 5 associated with remote audio recording session 700 includes the following sequence of operations:
Once the recording is complete, studio user 702 may stop the recording via studio application 706. In an aspect, studio user 702 may perform this operation by pressing and toggling the RECORD button 580 displayed on GUI 516.
Studio application 706 may communicate to client application 708 (e.g., via server 710) to stop the recording.
Client application 708 may stop the recording and display a corresponding message to client user 704.

Referring again to FIG. 7D, a step 6 associated with remote audio recording session 700 includes the following sequence of operations:
After recording has been stopped, a keep or retake option may be displayed via GUI 516, on studio application 706.
If the keep option is selected, the recording is automatically transferred from studio application 706 to server 710.
The recording may also be transferred from server 710 to studio application 706.
The studio application 706 may place the recording on a timeline for review by studio user 702.

Referring now to FIG. 7E, a step 7 associated with remote audio recording session 700 includes the following sequence of operations:
If a retake option is selected, then studio user 702 selects a retake option via studio application 706.
Studio application 706 may communicate with client application 708 to delete the recording.

Referring again to FIG. 7E, a step 8 associated with remote audio recording session 700 includes the following sequence of operations:
If the keep option is selected, client application 708 saves data associated with the recording to server 710.
The recording may automatically be stored on server 710.
The studio user 702 may request to retrieve the saved recording via studio application 706.
In response, studio application 706 may automatically request server 710 to get the recording.
The server 710 may send the recording to studio application 706.

Referring now to FIG. 7F, a step 9 associated with remote audio recording session 700 includes the following sequence of operations:
Once studio application 706 receives the recording, studio application 706 may display the recording to studio user 702.
Studio application 706 may automatically request server 710 to delete the recording. This provides data protection for the artist.
Server 710 may delete the recording in response to the request.

Referring again to FIG. 7F, a step 10 associated with remote audio recording session 700 includes the following sequence of operations:
Studio application 706 may request a remote control operation to client application 708 via server 710. This remote control operation enables studio user 702 to remotely control operations associated with client application 708 via studio application 706.
In response to the request, server 710 may launch a WebRTC studio monitor on studio application 706. The WebRTC studio monitor enables studio user 702 to remotely control operations associated with client application 708 via studio application 706.

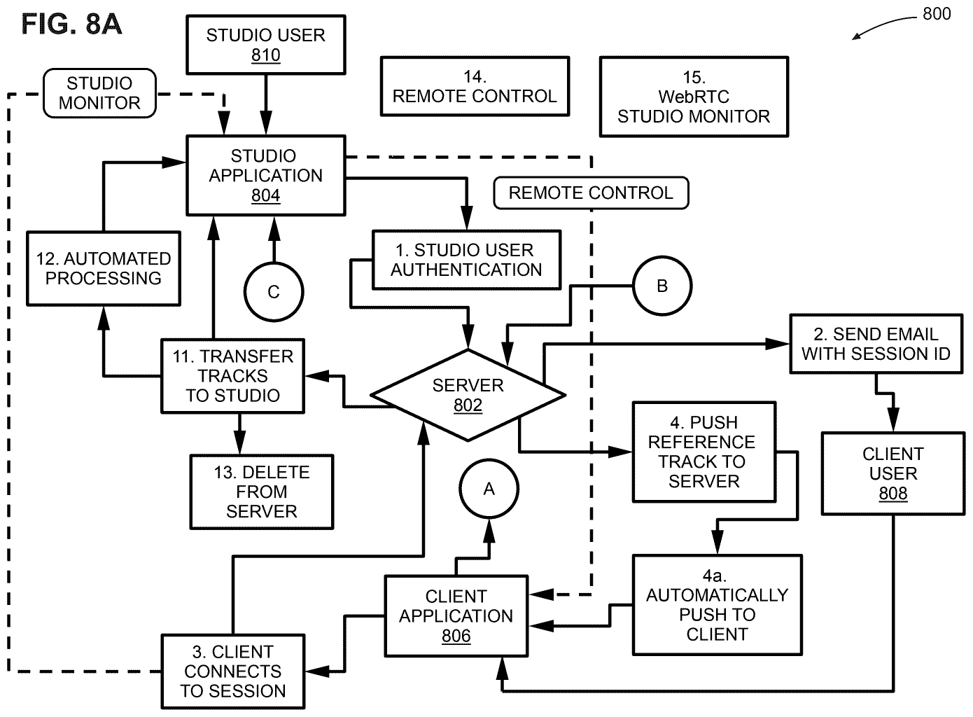

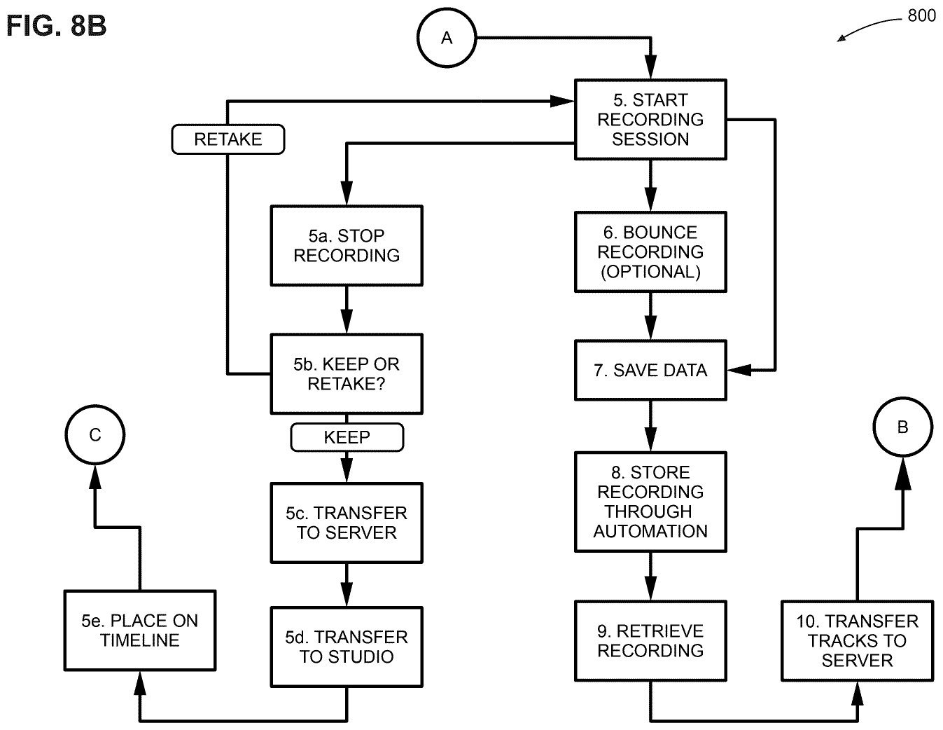

FIGS. 8A-8B are flow diagrams depicting a method 800 to implement a remote audio recording session. The remote audio recording session method 800 may be implemented by remote audio recording system 200.

Referring to FIG. 8A, as a part of method 800, studio user 810 (e.g., studio user 702) logs in to studio application 804 (e.g., studio application 706). The following sequence then is performed by remote audio recording system 200:

### 1. Studio User Authentication:

The studio user 810 logs into the studio application 804.
The studio application 804 authenticates the user with server 802 (e.g., an AWS server).
   2. Send Email with Session ID:
The studio user 810 initiates a session.
The server 802 generates a Session ID.
The server 802 sends an email containing the Session ID to the client user 808

(e.g., client user 704).

### 3. Client Connects to Session:

The client user 808 receives the email and opens the client application 806 (e.g., client application 708).
The client application 806 connects to the session using the provided Session ID.
Once connected, the WebRTC studio monitor is established between the studio application 810 and the client application 806.

### 4. Push Reference Track:

The studio user 810 pushes a reference track to server 802.
The reference track is then automatically pushed to the client application 806 from the server 802 (4a.).

The discussion of stages 5 through 9 follows the portion of process flow 800 depicted in FIG. 8B.

### 5. Start Recording Session:

The studio user 810 initiates the recording by pushing the start recording command (e.g., RECORD button 580).
The server 802 receives the command and starts recording the session.
The session is recorded and stored temporarily on the server 802.
   5a. Stop Recording:
The studio user 810 stops the recording session.
   5b. Keep or Retake?:
The studio user 810 is given a choice to keep the recording or retake it.
If “Keep” is selected, the recording is transferred to server 802.
If “Retake” is selected, the recording is deleted and the setup is ready to record again, going back to 5.
   5c. Transfer to AWS:
The recording is transferred to the server 802 if the “Keep” option is selected.
   5d. Transfer to Studio:
The recording is then automatically transferred from server 802 to the studio application 804.
   5e. Place on Timeline:
The recording is placed on the song timeline at the exact location it was recorded.

### 6. (Optional) Bounce Recording:

If needed, the recording can be bounced for review or editing before finalizing.

### 7. Save Data:

The recorded data is saved on the client side and then prepared for transfer.

### 8. Store Recording (AWS) Through Automation:

The recording is securely stored on the server 802 infrastructure through automation by the server 802.

### 9. Retrieve Recording:

The studio user 810 can retrieve the recording from server 802 for further processing.

### 10. Transfer Tracks to Server 802:

The recorded tracks are automatically transferred from the client application 806 to the server 802.

The discussion of stages 11 through 15 follows the portion of process flow 800 depicted in FIG. 8A.

### 11. Transfer Tracks to Studio:

From server 802, the tracks are transferred to the studio application 804 for further processing.

### 12. Automated Processing:

The studio application 804 processes the tracks through automation.
The processed tracks are available for retrieval and further actions by the studio user 810.
   13. Delete from Server 802:
Once the tracks are transferred to the studio, they are deleted from server 802 to ensure security and manage storage.

### 14. Remote Control:

The studio application 810 has remote control over the client application 806 to manage the recording process.

### 15. WebRTC Studio Monitor:

WebRTC technology is used to establish a real-time monitoring connection between the studio application 810 and client application 806.

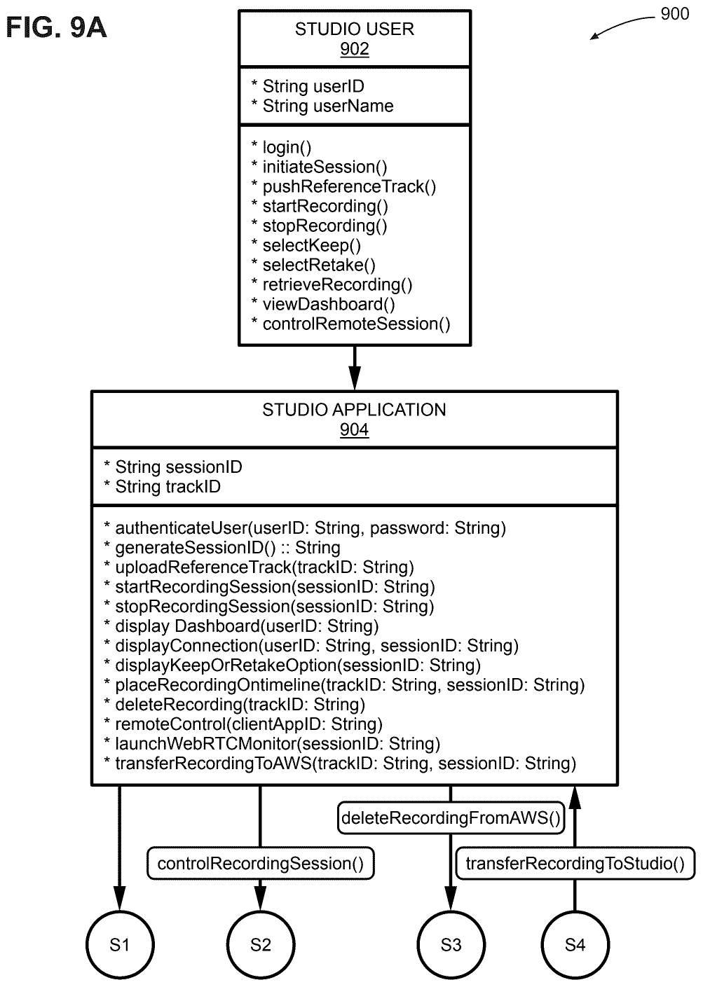

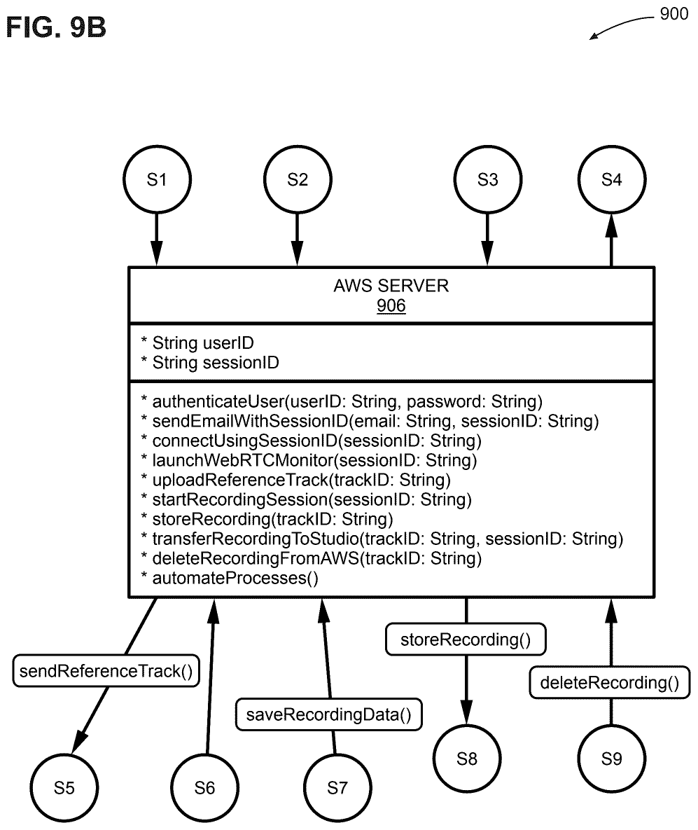

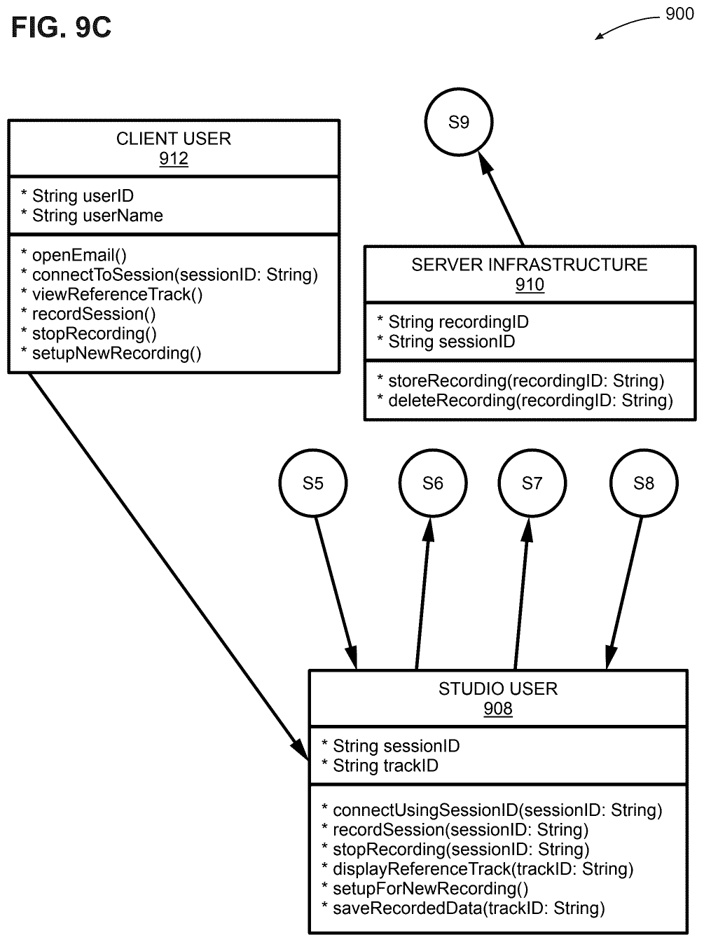

FIGS. 9A-9C are data structure diagrams 900 depicting different data structures and algorithmic functions associated with an implementation of a remote audio recording session.

Referring to FIG. 9A, studio user 902 is associated with a set of data structures and algorithmic functions that are used to interface with studio application 904. Studio application 904 has its own set of data structures and algorithmic functions.

Studio application 904 interfaces with AWS server 906 (FIG. 9B) via a set of algorithmic functions passing data back and forth between studio application 904 and AWS server 906. Examples of such functions are presented in FIGS. 9A and 9B.

Referring to FIG. 9B, AWS server 906 has its own set of data structures and algorithmic functions, that enables AWS server to further connect with server infrastructure 910 (FIG. 9C) and studio user 908 (FIG. 9C). As shown in FIG. 9C, studio user also receives inputs from client user 912. Each of client user 912, server infrastructure 910, and studio user 908 is associated with a unique set of data structures and algorithmic functions.

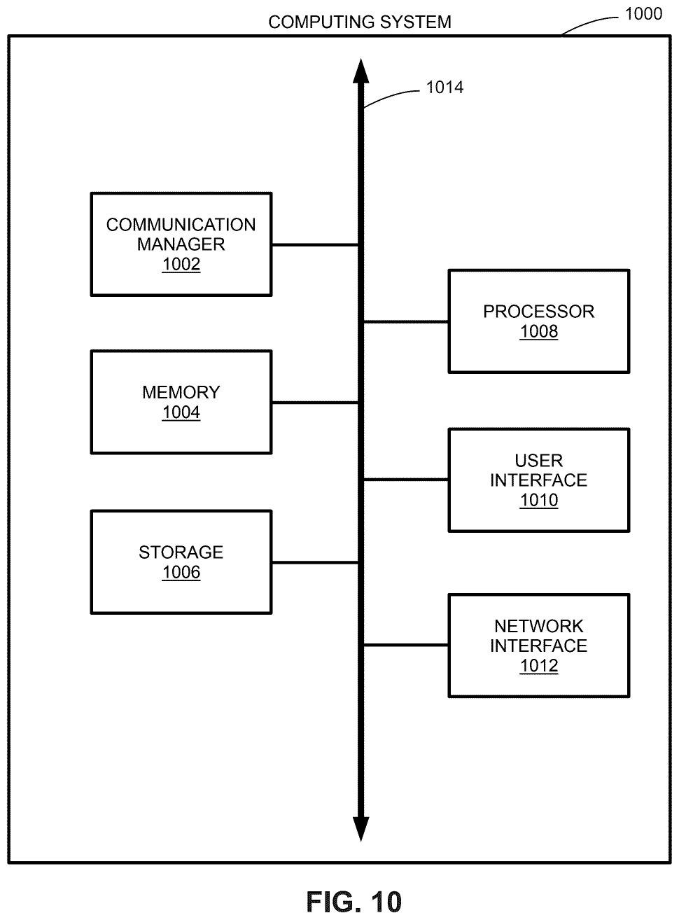

FIG. 10 is a block diagram depicting an embodiment of a computing system 1000. As depicted, computing system includes communication manager 1002, memory 1004, storage 1006, processor 1008, user interface 1010, network interface 1012, and system bus 1014. Computing system 1000 may be used to implement aspects of the systems and methods described herein, such as computing system 500, studio host computer 202, and client computer 206.

In an aspect, communication manager 1002 is configured to manage communication protocols and associated communication with external peripheral devices as well as communication with other components in computing system 1000.

In an aspect, memory 1004 is comprised of any combination of volatile and non-volatile memory components. Examples of components that may be used to implement memory 1004 include random-access memory (RAM), read-only memory (ROM), electrically-erasable programmable read-only memory (EEPROM), flash memory, magnetic memory, optical memory, and so on. Memory 1004 may include machine-readable instructions that may be executable by a processor such as processor 1008. These machine-readable instructions, when executed by the processor 1008, cause the processor 1008 to perform one or more method steps of an embodiment described herein.

Storage 1006 may be used for long-term storage of data associated with computing system 1000. Storage 1006 may include nonremovable and removable storage components. Nonremovable storage components such as hard disk drives, flash drives, etc. may be included in storage 1006. Removable storage components such as USB flash drives, compact disks (CDs), digital versatility disks (DVDs), etc. may be included in storage 1006.

A processor 1008 included in some embodiments of computing system 1000 is configured to perform functions that may include generalized processing functions, arithmetic functions, and so on. Processor 1008 is configured to process information associated with the systems and methods described herein. Processor 1008 may be configured as any combination of microcontrollers, microprocessors, digital signal processors (DSPs), field-programmable gate arrays (FPGAs), graphics processing units (GPUs), accelerated processing units (APUs), central processing units (CPUs), application-specific integrated circuits (ASICs), and so on. Processor 1008 may be embodied as a single-core processor, or a multi-core processor. Processor 1008 may be implemented as a centralized processor, or in a distributed manner (e.g., a distributed computing system).

User interface 1010 allows other devices or a user to interact with embodiments of the systems described herein. User interface 1010 may include any combination of user interface devices such as a keyboard, a mouse, a trackball, one or more visual display monitors, touch screens, incandescent lamps, LED lamps, audio speakers, buzzers, microphones, push buttons, toggle switches, and so on. User interface 1010 may alco include interfaces such as USB, Thunderbolt and FireWire that enable computing system 1000 to interface with different devices.

Network interface 1012 may be used to interface computing system 1000 with other computing devices and/or computer networks. Examples of computer networks include a local area network (LAN), a wide area network (WAN), the Internet, and so on. Network interface 306 may support any combination of wired and wireless connectivity/communication protocols such as Ethernet, Wi-Fi, Bluetooth, ZigBee, etc.

System bus 1014 communicatively couples the different components of computing system 1000, and allows data and communication messages to be exchanged between these different components.

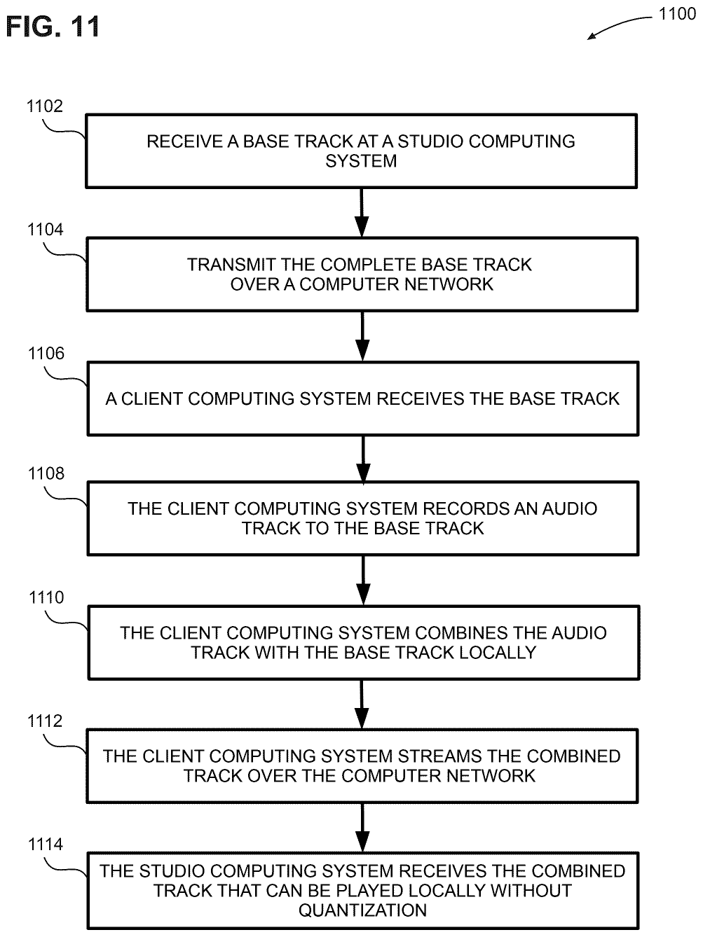

FIG. 11 is a flow diagram depicting a method 1100 to implement a remote audio recording session. Method 1100 may include a studio computing system receiving a base track (1102). For example, studio host computer 202 may receive a base track as a part of a collaborative audio recording session. Method 1100 may include the studio computing system transmitting the complete base track over a computer network (1104). For example, studio host computer 202 may transmit/stream the complete base track over network 104 (302).

Method 1100 may include a client computer system (e.g., client computer 206) receiving the base track (1106). The client computing system may record an audio track to the base track (1108). For example, client computer 206 may record audio to the base track (304).

Method 1100 may include the client computing system combining the audio track with the base track locally (1110). For example, client computer 206 combines the recorded audio with base track locally (306).

Method 1100 may include the client computing system streaming the combined track over the computer network (1112). For example, client computer 206 may stream the combined track over network 104 (308).

Method 1100 may include the studio computing system receiving the combined track that can be played locally without quantization (1114). For example, studio host computer 202 may receive the combined track that can be played locally without quantization (310).

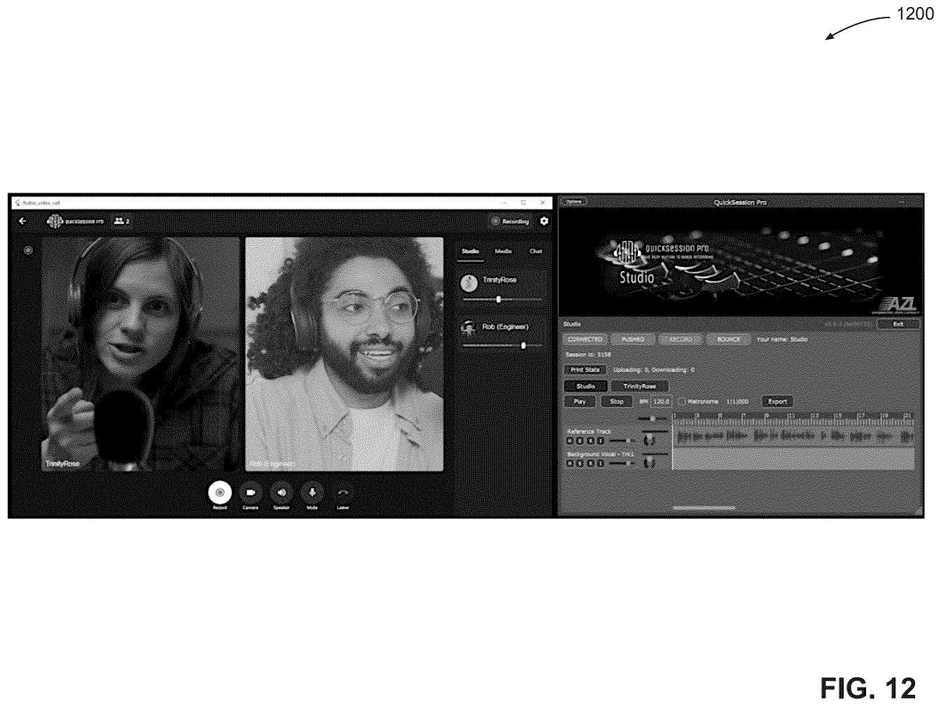

FIGS. 12-18 are screenshots of different graphical user interfaces associated with a remote audio recording system.

FIG. 12 is a screenshot 1200 depicting a connected session associated with remote audio recording system 200. FIG. 12 depicts a video call between a studio user and a client user. Screenshot 1200 also depicts a GUI displaying an audio recording session, including a timeline.

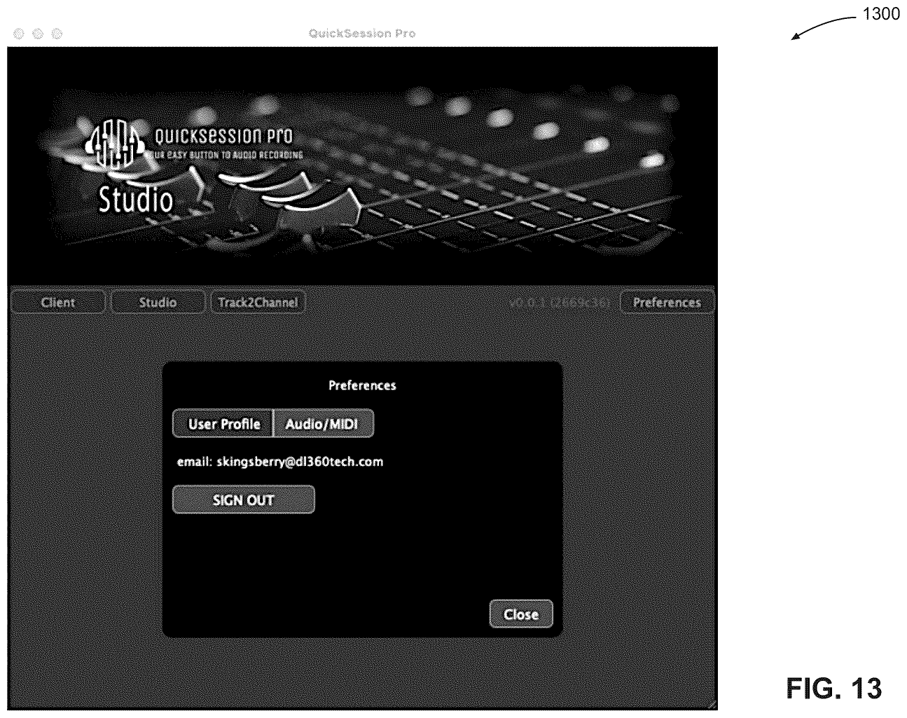

FIG. 13 is a screenshot 1300 depicting a GUI associated with a user authentication process. This GUI may be displayed on studio host computer 202 for studio user authentication, and/or on client computer 206 for client user authentication.

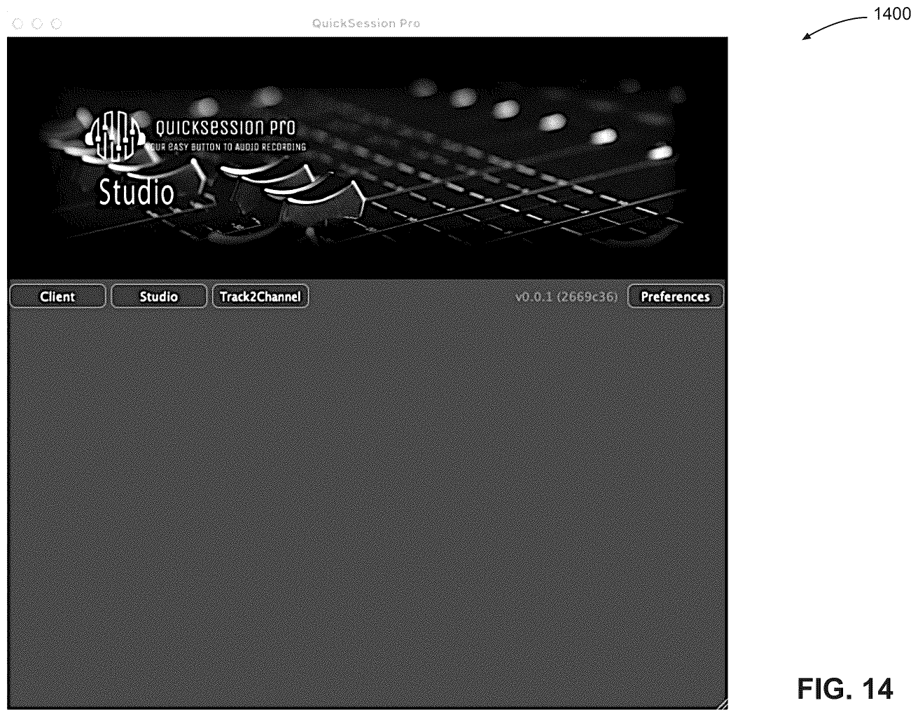

FIG. 14 is a screenshot 1400 depicting a starting page associated with remote audio recording system 200. This starting page may be displayed on both studio host computer 202 and client computer 206 upon respective user login after successful authentication.

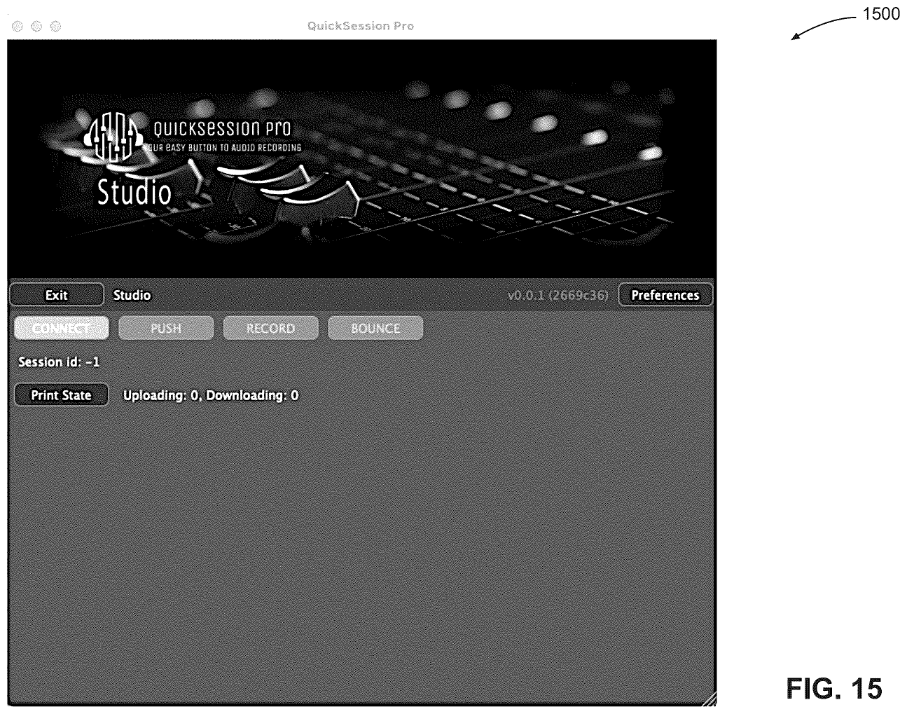

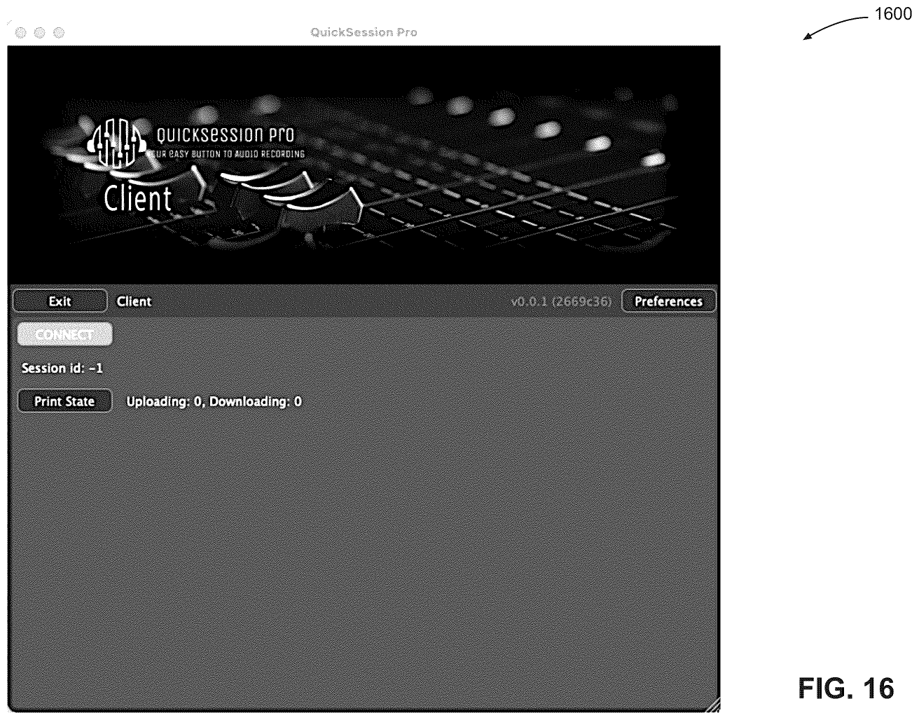

FIG. 15 is a screenshot 1500 depicting a starting page for a studio user working on studio host computer 202. FIG. 15 also shows the CONNECT, PUSH, RECORD, and BOUNCE buttons, similar to those depicted in FIG. 5D.

FIG. 16 is a screenshot 1600 depicting a starting page for a client user working on client computer 206.

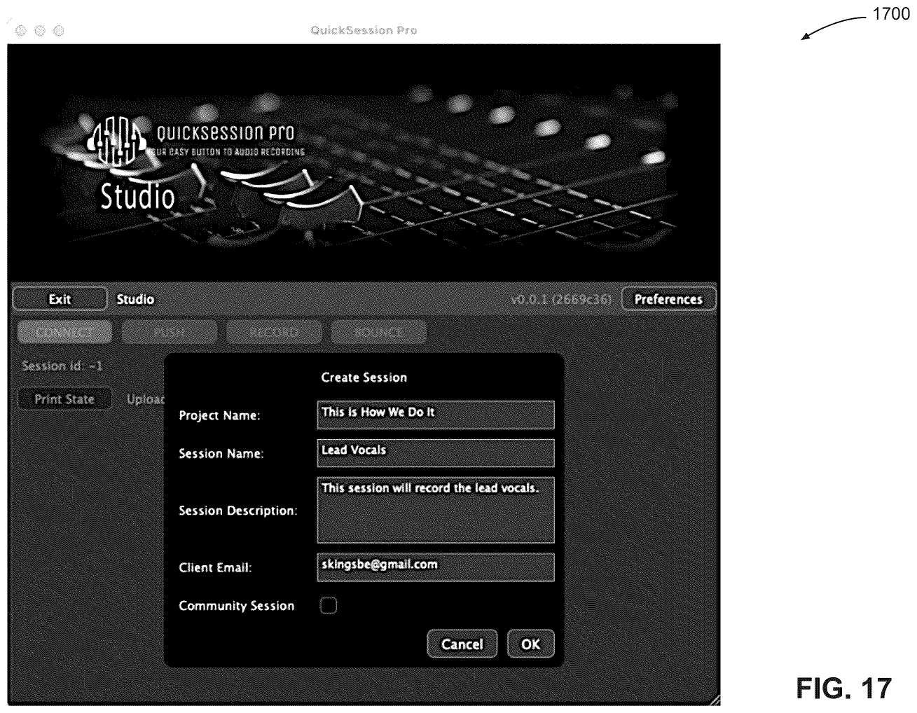

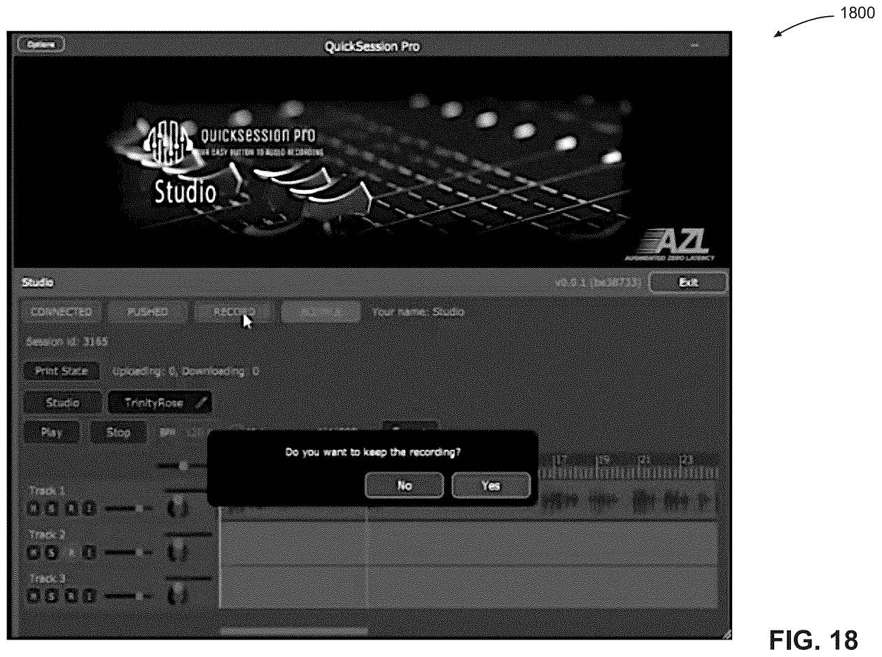

FIG. 17 is a screenshot 1700 depicting an interface displayed on studio host computer 202 that enables a studio user to create a session.

FIG. 18 is a screenshot 1800 depicting a recorded track as displayed on studio host computer 202. Screenshot 1800 also depicts a dialog box asking the user whether they want to keep the recording (e.g., 5b in method 800).

Features of remote audio recording system 200 include:
Integrated Augmented Zero Latency System: Combines cloud architecture, asynchronous coding, and real-time audio and video routing using WebRTC to achieve seamless, real-time remote music recording.
Cloud-Based Architecture: The use of Amazon Web Services (AWS) S3 for scalable and secure cloud storage, alongside AWS API Gateway for efficient request routing, ensures robust data management and real-time collaboration capabilities.
Asynchronous Coding: This technology allows concurrent execution of tasks, minimizing delays in operations such as data fetching and network requests, thus ensuring real-time remote control of client applications during recording sessions.
WebRTC Integration: By incorporating WebRTC, remote audio recording system 200 enables real-time audio and video communication, providing a professional studio monitoring experience for remote participants, thereby maintaining the quality and immediacy of in-person sessions.
Comprehensive Security Measures: The platform integrates AES-256 encryption for data at rest and SSL/TLS for data in transit, alongside robust authentication mechanisms, including username and password protections, to safeguard intellectual property and prevent unauthorized access.
User-Centric Design: The intuitive interface, featuring four primary actions (Connect, Push, Record, Bounce), simplifies the recording process, making it accessible for users at all levels of expertise while maintaining professional-grade quality.
Local and Cloud Recording Capabilities: Remote audio recording system 200 allows for local recording on the client side, with subsequent seamless transfer of audio files to the studio environment, ensuring that recordings are accurately aligned on the timeline.
JUCE and Tracktion Engine Integration: The integration of JUCE for cross-platform compatibility and the Tracktion Engine for high-level audio sequencing enables remote audio recording system 200 to deliver a consistent and reliable user experience across different DAWs and operating systems.
Scalability and Flexibility: The platform's modular design allows it to function as both a standalone application and a plugin compatible with popular DAWs, enhancing its versatility in various recording setups.
End-to-End Automation: From secure session establishment through email invitation and session ID generation to automated file transfers and timeline alignment, backend processes associated with remote audio recording system 200 are intricately automated to ensure efficiency and reliability.
Easy Button for Recording: A minimalist design philosophy and backend automation associated with remote audio recording system embody the “easy button” concept, democratizing high-quality remote music recording by making advanced functionalities accessible to all users.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
a studio computing system receiving a base track of a first audio recording;
the studio computing system transmitting the base track over a computer network;
a client computing system receiving the base track via the computer network;
the client computing system recording an audio track of a second audio recording, wherein the audio track is substantially time-synchronized with the base track;
the client computing system combining the audio track with the base track to generate a combined audio track;
the client computing system transmitting the combined audio track over the computer network;
the studio computing system receiving the combined audio track via the computer network; and
the studio computing system playing the combined audio track without any network-induced time quantization error or time synchronization error between the base track and the audio track.

2. The method of claim 1, wherein the combining substantially eliminates any effects of a network delay, wherein the network delay results in a lack of synchronization between the base track and the audio track, and wherein the network delay is associated with the computer network.

3. The method of claim 1, wherein at least one operation of the studio computing system is performed by a plugin instantiated on a digital audio workstation (DAW) installed on the studio computing system.

4. The method of claim 3, wherein the DAW includes a Tracktion engine.

5. The method of claim 1, wherein at least one operation of the client computing system is performed by a plugin instantiated on a DAW installed on the client computing system.

6. The method of claim 5, wherein the DAW includes a Tracktion engine.

7. The method of claim 1, further comprising initiating and conducting a video call between the studio computing system and the client computing system.

8. The method of claim 1, further comprising independently and separately authenticating a studio user and a client user on the studio computing system and the client computing system, respectively.

9. The method of claim 1, further providing a keep or retake option for the audio track on the client computing system.

10. The method of claim 9, further comprising re-recording the audio track to generate a re-recorded audio track if the retake option is selected.

11. The method of claim 9, further comprising deleting the audio track if the retake option is selected.

12. The method of claim 1, wherein:
the studio computing system transmitting the base track over a computer network comprises the studio computing system uploading the base track to a server via the computer network;
the client computing system receiving the base track via the computer network comprises the client computing system downloading the base track from the server via the computer network;
the client computing system transmitting the combined audio track over the computer network comprises the client computing system uploading the combined audio track to the server via the computer network; and
the studio computing system receiving the combined audio track via the computer network comprises the studio computing system downloading the combined audio track from the server via the computer network.

13. The method of claim 12, wherein the server is an Amazon Web Services (AWS) server.

14. A system comprising:
a studio computing system;
a client computing system; and
a computer network, wherein:
the studio computing system receives a base track of a first audio recording;
the studio computing system transmits the base track over the computer network;
the client computing system receives the base track via the computer network;
the client computing system records an audio track of a second audio recording, wherein the audio track is substantially time-synchronized with the base track;
the client computing system combines the audio track with the base track to generate a combined audio track;
the client computing system transmits the combined audio track over the computer network;
the studio computing system receives the combined audio track via the computer network; and
the studio computing system plays the combined audio track without any network-induced time quantization error or time synchronization error between the base track and the audio track.

15. The system of claim 14, wherein the combining substantially eliminates any effects of a network delay, wherein the network delay results in a lack of synchronization between the base track and the audio track, and wherein the network delay is associated with the computer network.

16. The system of claim 14, wherein at least one operation of the studio computing system is performed by a plugin instantiated on a DAW installed on the studio computing system.

17. The system of claim 16, wherein the DAW includes a Tracktion engine.

18. The system of claim 14, wherein at least one operation of the client computing system is performed by a plugin instantiated on a DAW installed on the client computing system.

19. The system of claim 18, wherein the DAW includes a Tracktion engine.

20. The system of claim 14, wherein a video call is initiated and conducted between the studio computing system and the client computing system.

21. The system of claim 14, wherein a studio user and a client user on the studio computing system and the client computing system respectively are respectively independently and separately authenticated.

22. The system of claim 14, wherein a keep or retake option for the audio track is provided on the client computing system.

23. The system of claim 22, wherein if the retake option is selected, the audio track is re-recorded to generate a re-recorded audio track.

24. The system of claim 22, wherein if the retake option is selected, the audio track is deleted.

25. The system of claim 14, wherein:
the studio computing system transmitting the base track over a computer network comprises the studio computing system uploading the base track to a server via the computer network;
the client computing system receiving the base track via the computer network comprises the client computing system downloading the base track from the server via the computer network;
the client computing system transmitting the combined audio track over the computer network comprises the client computing system uploading the combined audio track to the server via the computer network; and
the studio computing system receiving the combined audio track via the computer network comprises the studio computing system downloading the combined audio track from the server via the computer network.

26. The system of claim 25, wherein the server is an Amazon Web Services (AWS) server.

27. A system comprising:
a server;
a studio computing system; and
a client computing system, wherein:
the studio computing system receives a base track of a first audio recording;
the studio computing system uploads the base track to the server;
the client computing system downloads the base track from the server;
the client computing system records an audio track of a second audio recording, wherein the audio track is substantially time-synchronized with the base track;
the client computing system combines the audio track with the base track to generate a combined audio track;
the client computing system uploads the combined audio track to the server;
the studio computing system downloads the combined audio track from the server; and
the studio computing system plays the combined audio track without any time quantization error or time synchronization error between the base track and the audio track.
